(19) United States
(12) Patent Application Publication
(10) Pub. No.: US 2011/0202424 A1
(43) Pub. Date: Aug. 18, 2011

(54) RICH CONTENT CREATION, DISTRIBUTION, AND BROADCASTING SYSTEM

(75) Inventors: Jaeyoung Chun, Lynnwood, WA (US); Jeong Min Kim, Morristown, NJ (US)

(73) Assignee: MOTIONCLOUD INC

(21) Appl. No.: 12/745,541

(22) PCT Filed: Nov. 29, 2008
(86) PCT No.: PCT/US08/85088

§ 371 Date: Nov. 19, 2010

(30) Foreign Application Priority Data
Nov. 30, 2007 (KR) 10-2008-0123689

(51) Int. Cl. G06F 15/16; G06Q 30/00; G06Q 10/00

(52) U.S. Cl. 705/26.8; 705/27.1; 705/304; 709/203; 709/206

(57) ABSTRACT

A system for creating rich content displayable on a webpage. The system includes content files stored on a server and an editor displayed by a client in a Rich Internet Application (‘RIA’). The editor has a region into which content objects may be inserted to create a rich content item. At least a portion of the content objects are linked to content files stored on the server. The system generates a code segment operable to generate a display on a webpage based on the rich content item that does not use the RIA. The display is substantially equivalent to the rich content item displayed in the editing region using the RIA. The code segment is configured to be search engine friendly. The system may broadcast a common Rich Content item between a Broadcaster and a viewer both of whom may edit the Rich Content item at the same time.

### CROSS REFERENCE TO RELATED APPLICATION(S)

This application is a continuation-in-part of and claims foreign priority under the Paris Convention to Korean Patent Application Serial No. 10-2007-0123689 having Received Number 1-1-2007-0866215-21, filed Nov. 30, 2007 in the Republic of Korea (South Korea).

### BACKGROUND OF THE INVENTION

1. Field of the Invention

The present invention is directed generally to content creation systems and more particularly to online content creation systems configured to create and edit dynamic content, such as videos, and provide real time interaction between users.

2. Description of the Related Art

Many people wish to share their thoughts, feelings, and lives with other people. This desire is evident on the Internet where, according to a study done by Technorati in April of 2007, 120,000 new blogs are created every day, and the 1.5 million posts are made to the Blogosphere daily.

As the desire to produce User-Created Content (“UCC”) or User-Generated Content (“UGC”) has increasing, so has the number of services such as MySpace, Facebook, Blogs, Flickr, and YouTube, where various forms of contents can be posted and shared. However, the majority of such services do not aid in the creation of UCC but rather allow users to upload content already created using other tools. Thus, creating UCC often involves the use of applications other than those used to distribute the UCC.

For example, if a user wants to post annotated photographs of his/her vacation to Paris on a website like Flickr, the photographs taken with a digital camera must be first stored on a user's hard drive. Then, an image-editing tool such as Adobe Photoshop must be used to annotate the photographs. Finally, the annotated photographs may be uploaded to the web. Knowledge of technologies such as Hypertext Markup Language (“HTML”), Cascading Style Sheets (“CSS”), and the like may be necessary to format the uploaded photographs and/or webpage so the photographs blend in well with other items. To attach a map of Paris, the city must be located using a map service (such as Google Maps) and an image capture tool used to capture an image of the map produced by the map service. After the image is captured, it may be edited (e.g., annotated) using an image editing application, such as Adobe Photoshop. Finally, the map image may be uploaded to the website for display.

Because successive operations are often required to create UCC, users who wish to create their own content must have suitable technical backgrounds and/or invest a lot of time to create their content. These requirements constrain user expression. This is particularly true in the case of Rich Content because it combines text, images, video, music, and the like. This type of content is typically expensive to create and is often created by professional content creators. Recent studies have estimated that newly created UCC is less than 20% of what it would be if these limitations were removed.

Below is an explanation of several exemplary prior art content creation methods.

### 1) Adobe Photoshop

Adobe Photoshop targets professional graphic designers and to use the application to create content at least one month of training is required. The application is somewhat expensive for users, costing about $600 in 2007. Images produced using Adobe Photoshop are not search engine friendly. To expose the image to a search engine, a Search Engine Optimization (“SEO”) consultant can be employed or HTML source code used to post the image can be edited. Therefore, the average user does not use Photoshop to create content but rather hires a professional designer. Further, Adobe Photoshop is not configured to create or edit dynamic content, such as music, video, and the like, that may be used in Rich Content. Therefore, the creation of Rich Content using Adobe Photoshop alone is not possible.

### 2) Microsoft PowerPoint

While an average user may be able to readily create content using Microsoft PowerPoint, the file created (i.e., *.PPT) is not search engine friendly. Further, while dynamic elements such as video and music can be incorporated into a presentation displayed using Microsoft PowerPoint, when each of the slides are transformed into an image (such as a JPEG format image) to be posted on the Internet, the dynamic elements are omitted. Because the final product produced using Microsoft PowerPoint is an image file, content produced using Microsoft PowerPoint has the same limitations as content produced using Adobe Photoshop.

### 3) Adobe Flash/Microsoft Silverlight

Adobe Flash, Microsoft Silverlight, and similar technologies may be used to develop dynamic and interactive Rich Content. However, to create such content, professional computer graphics designers and professional programmers knowledgeable in various computer languages (such as ActionScript, XAML, MXML, C#, Javascript, HTML, CSS, etc.) are required. These requirements bring with them high costs, long creation times, etc.

While content created using Adobe Flash or Microsoft Silverlight are gaining attention as a new medium for product publicity, advertising, and sales because such content is fancier and more emotionally appealing than traditional web content created using HTML, the content is not exposed to search engines. Thus, to create search engine friendly Rich Content, designers, programmers, and SEO consultants must work together as a team from the early states to the final stages of the content creation, making the creation of Rich Content using Adobe Flash, Microsoft Silverlight, and similar technologies virtually impossible for the average user.

Even if a user wants to create Rich Content him/herself, more sophisticate Rich Content projects are generally outsourced to expert Rich Internet Application (“RIA”) developers and designers. After the RIA developers and designers create the Rich Content, a SEO consultant will typically rework the Rich Content to expose it to search engines. This method not only has the problems of high costs and long development periods but it may also result in an unsatisfactory final product as a result of one or more miscommunications between the designer and the user, the correction of which could lead to addition cost and time investments.

Thus, a need exists for a Rich Content creation tool or system in which all of the operations required to create Rich Content occur within a Web Browser without requiring any additional software. A further need exists for a tool or system that allows a user to create Rich Content with an easy to use interface, e.g., a Drag & Drop interface, Point & Click interface, and the like, not requiring knowledge of complex content creation software such as Adobe Photoshop or computer languages such as HTML, CSS, and like. It would be further desirable for such a tool or system to enable an average person to create Rich Content without any technological background. Additionally, a need exists for a tool or system that works cross-platform (e.g., Windows, Mac, LINUX, etc.) and across browsers (e.g., Internet Explorer, Firefox, Safari, Opera, Konqueror, etc.) making the tool or system platform and browser independent. In this manner, a first user may create Rich Content in any client environment and a second user may consume (or experience) that Rich Content in any client environment. A need also exists for a Rich Content creation tool or system that enables a user to share Rich Content with other people using third party services such as MySpace, Facebook, LiveJournal, etc. In addition, if the Rich Content is distributed to a plurality of mediums, it is desirable for edits made to the Rich Content in a single location to be automatically reflected in all of the other mediums in real time. It is further desirable to expose information in the Rich Content to search engines by creating a form of Rich Content that can be indexed by Search Engine Crawlers without any additional manual SEO. A further need exists for a system that makes real time information exchange and collaboration possible by allowing users to broadcast Rich Content on the Internet in real time without any special devices or technological background.

The present application provides these and other advantages as will be apparent from the following detailed description and accompanying figures.

### SUMMARY OF THE INVENTION

Aspects of the present invention relate to a system for creating Rich Content displayable on a webpage by a web server. The system includes a plurality of content files each stored on a server in a storage location and a Rich Content editor displayed in a display unit coupled to a client computing device in communication with the server over a network. The Rich Content editor may be displayed by an Internet browser application executing on the client computing device.

The Rich Content editor includes an editing region and a plurality of content objects each insertable into the editing region by a user and when inserted, displayable inside the editing region. Each of the content objects is linkable to the storage location of a selected one of the plurality of content files stored on the server.

The Rich Content editor is used to create a Rich Content item that is both displayable and editable by the Rich Content editor. The Rich Content item includes at least a portion of the plurality of content objects, each having a position inside the editing region and being linked to the storage location of a selected one of the plurality of content files stored on the server. The Rich Content item may be stored and transmitted as a segment of XML code. The system includes a save function operable to store the Rich Content item on the server.

The system further includes a code generation function configured to generate a distributable code segment operable to generate a first display on a webpage based on the Rich Content item. When displayed by a web server on a webpage, the first display is substantially equivalent to the Rich Content item displayed in the editing region. The distributable code segment may include a segment of HTML code. Optionally, the distributable code segment may include a segment of XML code.

Optionally, the system may include a preview function configured to generate a second display substantially equivalent to the first display when displayed on a webpage by a web server.

The plurality of content objects may include an embedded code type object configured to receive a segment of code, identify a service associated with the code, request information from the service related to the segment of code, and display the requested information in the editing region.

Depending upon implementation details, the system may include a content file processing function configured to upload a content file from the client computing device to the server, store the uploaded content file in a storage location, and add the uploaded content file to the plurality of content files.

The system may be configured for use with a content file sharing service. In such embodiments, the system includes a content file sharing function configured to use the content file sharing service to identify a particular content file, upload that particular content file to the server, store the uploaded content file in a storage location, and add the uploaded content file to the plurality of content files.

The system may include a broadcast function operable to open a broadcast channel between a first client computing device and a second client computing device, display a first Rich Content editor in a display unit coupled to the first client computing device operated by a first user, and display a second Rich Content editor in a display unit coupled to the second client computing device operated by a second user. When one of the first and second users inserts one of the plurality of content objects into the editing region of one of the respective first and second Rich Content editors, the broadcast function displays the inserted content object in the editing region of both the first and second Rich Content editors.

The system includes a save function operable to store a Rich Content item including any content objects inserted into the editing region of the first and second Rich Content editors, and for each inserted content object, a location of the inserted content object within the editing region of the first and second Rich Content editors. For at least a portion of the inserted content objects, the Rich Content item includes a link to a storage location of a selected one of the plurality of content files stored on the server. The code generation function may be used to generate a distributable code segment operable to generate a display on a webpage based on the Rich Content item that is substantially equivalent to the Rich Content item.

Further aspects of the present invention include a purchasing interface displayable to a buyer on a display device and for use with an electronic transaction service executing on a server in communication with the purchasing interface over a network. The electronic transaction service is configured to receive a purchase request indentifying a plurality of products from the purchasing interface over the network, and in response to receiving the purchase request, complete a purchase of the plurality of products identified in the purchase request.

The purchasing interface has a product offerings display screen with a plurality of selectable purchasing objects each associated with a different product. When selected, each of the selectable purchasing objects indicates a desire of a buyer to purchase the product associated with the selectable purchasing object. More than one selectable purchasing object may be selected before a purchase request to purchase the products associated the selected selectable purchasing objects is transmitted to the electronic transaction service. The product offerings display screen also includes a selectable purchase indicator that when selected creates a purchase request identifying the products associated with the selectable purchasing objects selected by the buyer and transmits the purchase request to the electronic transaction service over the network.

The purchasing interface may be configured for use with a product database storing information related to each of the different products associated with each of the plurality of selectable purchasing objects and a data management function configured to extract the information related to each of the different products associated with the plurality of selectable purchasing objects from the database and provide the extracted information to the plurality of selectable purchasing objects. Each of the selectable purchasing objects has a display portion displaying information related to the product associated with the selectable purchasing object extracted from the database by the data management function and provided to the selectable purchasing object by the data management function.

Aspects of the present invention include a method for use with an online map service that provides navigable electronic maps each having embedded therein a link to a website operated by a business. The method is performed by a first user, who navigates one of the navigable electronic maps provided by the service to the embedded link. Then, the first user activates the link and is directed thereby to the website operated by the business. The website is configured to initiate a customer service application that broadcasts information between the first user and a user associated with the business. The information may be broadcast in XML format. The first user activates the control to initiate the customer service application, which displays a Rich Content editing region to both the first user and the user associated with the business. The first user inserts content into the Rich Content editing region for broadcast by the customer service application to the user associated with the business. The first user also views content inserted into the Rich Content editing region by the user associated with the business and broadcast to the first user by the customer service application.

Either of the users may store any content in the Rich Content editing region as a Rich Content item using the save function, and at a later time, display the saved Rich Content item in the Rich Content editing region.

The content inserted into the Rich Content editing region by the user associated with the business may include an add-to-cart type object operable to initiate a purchase of a product. In such embodiments, the first user may activate the add-to-cart type object to initiate the purchase of the product.

Optionally, the customer service application displays a text chat display region to both the first user and the user associated with the business. In such embodiments, the first user chats with the user associated with the business by entering text into the text chat display region and viewing text entered into the text chat display region by the user associated with the business. Likewise, the user associated with the business chats with the first user by entering text into the text chat display region and viewing text entered into the text chat display region by the first user.

Optionally, the customer service application displays a pen tool to both the first user and the user associated with the business. The first user uses the pen tool to create a drawing in the Rich Content editing region. The drawing created is displayed in the Rich Content editing region displayed to both the first user and the user associated with the business.

Aspects of the present invention also relate to a method of transferring photographs captured by a camera coupled to a mobile station (e.g., a cellular telephone) from the mobile station to a remote server. The mobile station is associated with a user and has an identification number (e.g., a telephone number). The mobile station transmits a message including both the identification number of the mobile station and the image to a predetermined email address associated with the server. The message may be a Multimedia Message Service (“MMS”) message. The message may be transmitted to a messaging gateway, such as a Short Message Service (“SMS”) gateway.

Then, the transmitted message is received at the server. If the message was transmitted to the messaging gateway, receiving the message at the server includes connecting to the messaging gateway and downloading the message from the messaging gateway. The server may periodically contact the messaging gateway to determine whether any messages have been received by the messaging gateway and download any messages received.

For each message received at the server, the server obtains the identification number of a sending mobile station and the image from the message. The image is stored in a storage location that is associated with the sending mobile station and accessible by the user associated with the sending mobile station. When the server receives a request for the image from the user associated with the sending mobile station, the server reads the image from the storage location and provides the image to the user.

For each message downloaded, the server may use a database associating identification numbers of mobile stations with users to identify the user associated with the identification number of the sending mobile station obtained from the message.

In alternate embodiments, instead of transmitting the message including both the identification number of the mobile station and the image to a predetermined email address associated with the server, the mobile station dials a predetermined identification number (e.g., a telephone number) associated with the server and transmits the message to the server over the dial up connection.

### BRIEF DESCRIPTION OF THE SEVERAL VIEWS OF THE DRAWING(S)

FIG. 1 is block diagram of a Rich Content creation system.

FIG. 2 is a flow diagram of a method that may be performed by the system of FIG. 1.

FIG. 3 is an illustration of a Rich Content editing screen having a toolbar, editing region, and select wallpaper function generated by the system of FIG. 1.

FIG. 4A is an illustration of a first portion of a set of controls provided by the toolbar of the Rich Content editing screen of FIG. 3.

FIG. 4B is an illustration of a second portion of the set of controls provided by the toolbar of the Rich Content editing screen of FIG. 3.

FIG. 5A is an illustration of the Rich Content editing screen after an insert space control of the toolbar has been selected and a horizontal line has been inserted into the editing region.

FIG. 5B is an illustration of an amount of space specified for insertion by a user using the insert space control.

FIG. 5C is an illustration of the editing region after the amount of space specified by the user in FIG. 5B is inserted into the editing region by the insert space control.

FIG. 6 is an illustration of a file menu generated by a file menu control of the toolbar of the Rich Content editing screen of FIG. 3.

FIG. 7A is an illustration of a basic menu generated by selecting a content object in the editing region of the Rich Content editing screen of FIG. 3.

FIG. 7B is an illustration of a style menu generated by activating a style menu control of the basic menu of FIG. 7A.

FIG. 8 is an illustration of a style menu for a text type content object.

FIG. 9 is an illustration of a style menu for an image type content object.

FIG. 10 is an illustration of a style menu for a video type content object.

FIG. 11 is an illustration of a style menu for a speech bubble type content object.

FIG. 12 is an illustration of a style menu for an arrow type content object.

FIG. 13 is an illustration of a style menu for a map type content object.

FIG. 14 is an illustration of a style menu for an ink type content object.

FIG. 15 is an illustration of a style menu for a rectangle type content object.

FIG. 16 is an illustration of a broadcast screen generated by the system of FIG. 1 after a user activates a broadcast control of the file menu of FIG. 6.

FIG. 17 is an illustration of a list of broadcast channels generated by the system after a user activates a watch control of the file menu of FIG. 6.

FIG. 18 is a schematic diagram of a computer environment suitable for implementing components of the system of FIG. 1.

FIG. 19 is an illustration of a display having multiple add-to-cart type content objects generated by an embeddable code segment distributed in a final medium, the embeddable code segment having been generated by the system of FIG. 1.

### DETAILED DESCRIPTION OF THE INVENTION

Aspects of the present invention include a Rich Content creation system. The system allows users to create Rich Content items that may be used as online advertisements as well as to provide online customer service. The Rich Content items are created in a distributed application having a client program executing on a client computing device that interacts with a server components executing on a server. All content used to create the Rich Content items is uploaded to the server and stored thereby in storage locations.

The Rich Content items are created using a “What You See Is What You Get” (“WYSIWYG”) editor generated by the client program. The editor may be implemented inside a browser and may execute with the help of a RIA plug-in such as Adobe Flash, Microsoft Silverlight, and the like. A Rich Content item created using the editor generated by the client program may be uploaded to the server and stored thereby in a storage location. The Rich Content item may be transmitted and stored in XML format. At a later time, the editor may request the stored Rich Content item from the server. In response to the request, the server transmits the stored Rich Content item to the editor on the client computing device. The Rich Content item may be transmitted to the client computing device in XML format.

The client program creates a distributable version of each Rich Content item by generating a segment of embeddable code with references to the content stored in the storage locations. The user distributes a Rich Content item by embedding the segment of embeddable code in a final medium (such as a webpage). The embeddable code generates a display inside a webpage that is substantially identical to the Rich Content item as it appears to the user inside the editor.

Because the segment of embeddable code is created using references to storage locations, information related to each individual content item used to create a Rich Content item may be incorporated into the segment of embeddable code and exposed to search engines. Thus, any metadata associated with an image or other content used to create the Rich Content item, is searchable by search engines. The embeddable code may be generated in a format (such as HTML) that can be indexed by search engine crawlers and is therefore searchable by search engines. Thus, a user does not need to have knowledge of SEO to make the embeddable code (and display generated thereby) search engine friendly.

The system may also provide interactive customer service. Using the client program, a first user (“Broadcaster”) may open a broadcast channel, which will generate a broadcast interface. Using the client program, a second user (“Viewer”) remotely located relative to the first user may select the broadcast channel, which will generate the same broadcast interface viewed by the Broadcaster for viewing by the Viewer. The Broadcaster and Viewer may communicate with one another using the broadcast interface, which may include a Rich Content editing region, a video signal display portion for use with a video camera, a text chat display portion, an audio processing component for use with a microphone, and the like. The broadcast interface also allows the first and second users to edit a common Rich Content item displayed to both the Broadcaster and Viewer in their respective Rich Content editing regions.

Aspects of the system relate to a map based customer service application that allows a user to navigate within a map to a hyperlink to a website associated with a business. Activating the hyperlink directs the user to the website associated with the business. The website has a link to a broadcast interface that allows the user to interact with a second user at the business who can answer questions, suggest products, offer products for online purchase, and the like.

### DEFINITIONS

Unless defined otherwise, technical and computing related terms used herein have the same meaning as commonly understood by one of ordinary skill in the art to which this invention belongs. For purposes of the present application, the following terms are defined below.

Content: All information provided over the Internet. Content includes without limitation text, images, videos, Internet newspapers/news magazines, online advertisements, detailed information about products offered for sale on the Internet, messages posted on message boards, messages posted on web forums (such as web cafés) where people of the same or similar interests communicate, emails, blog postings, and the like.

Content Consumers: Users who consume content existing on the Internet. Consuming includes without limitation listening to, viewing, and reading.

Content Creators Users who create content that can be consumed over the Internet.

User Created Content (UCC) (also referred to as User Generated Content (“UGC”)): Content created directly by users and typically displayed without commercial intent.

Rich Internet Application (“RIA”) (also referred to as Rich Interactive Application): Applications that bring “full” and “rich” experiences to users over the Internet. RIA may be developed using technologies such as Adobe Flash, Open Laszlo, Microsoft Silverlight, Ajax, DHTML, and the like. Non-RIA web or Internet applications run within a web browser and are not as rich as applications executed on a desktop and include many inconveniences. In contrast, RIA applications may be as rich and convenient as desktop applications. Further, RIA applications may include interactive user interfaces superior to those provided by desktop applications. Because RIA applications are typically in binary format, they are not search engine friendly.

Rich Content: Content that includes images, videos, music, multimedia elements, and the like, including interactive functions. Rich Content is different from previously existing plain content, which includes only text. Rich Content is generally created using RIA technologies.

RIA Browser Plug-In (or RIA Plug-in): Additional software modules required to execute web applications created using RIA technologies in a web browser.

Search Engine Marketing (“SEM”): Marketing actions taken to bring visitors to a website by making the website searchable by search engines. The key to SEM is how much exposure the website has to search engines.

Search Engine Optimization (“SEO”): A series of action taken to improve the ranking of a website in search results returned by a search engine. When a particular keyword is searched by a search engine, the websites located by the search engine are displayed according to a ranking with the first website displayed having the highest possibility of being visited by the user who supplied the particular keyword. Most website operators want their website to have a high ranking. Because SEO typically involves analyzing and editing HTML source code, SEO is difficult for many users without technological backgrounds to perform.

SEO Consultant (or Service): A consulting person/company or service that performs SEO operations on a website to help that website achieve high rankings in search results returned by search engines.

Search Engine Friendly: Content, web pages, and websites that exist in machine-readable formats understood by search engines. SEO operations can be applied only to search engine friendly content. Content that is not search engine friendly cannot be searched using a search engine regardless of whether SEO is performed. Therefore, content planning must consider whether the content created and posted on the Internet is in a search engine friendly format.

### Rich Content Creation System

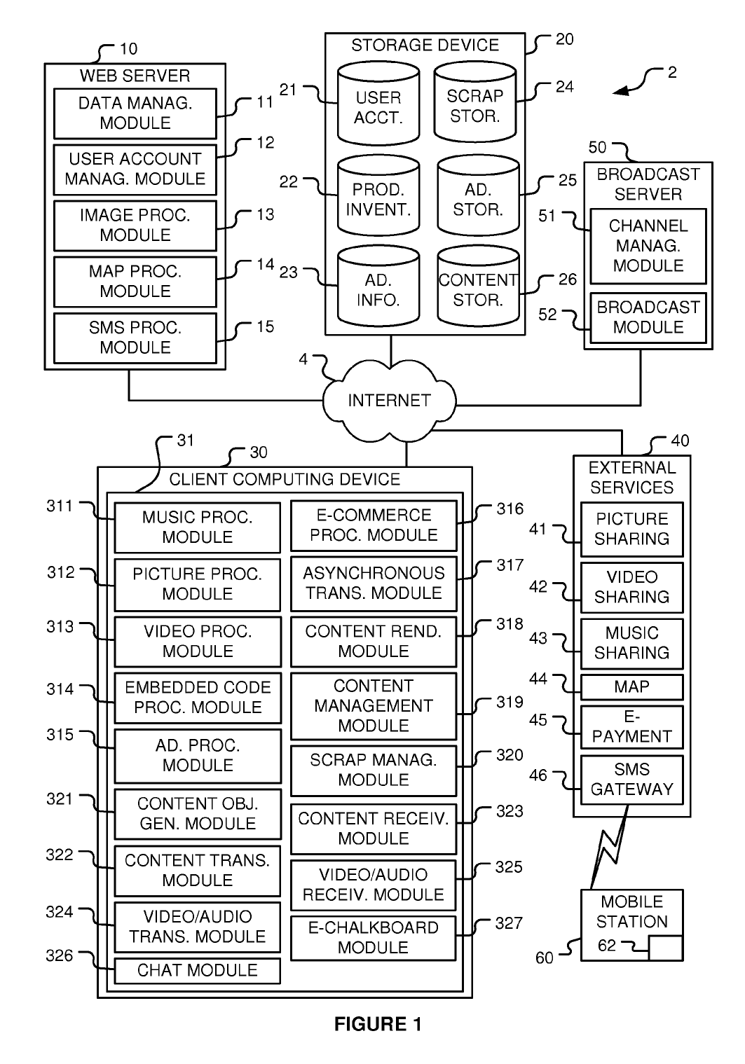

FIG. 1 provides a block diagram of a Rich Content creation system 2. The system 2 includes a web server 10, a storage device 20, a client computing device 30, an external service processor 40, and a broadcast server 50 interconnected by a network 4 (e.g., the Internet). Referring to FIG. 18, each of the web server 10, the storage device 20, the client computing device 30, the external service processor 40, and the broadcast server 50 may be implemented as a computing device 120 (described below). While the system 2 is illustrated as including a single web server 10, storage device 20, client computing device 30, external service processor 40, and broadcast server 50, those of ordinary skill in the art appreciate that embodiments including more than one of any of these components are within the scope of the present teachings. Further, the functionality of two or more of these components may be combined on a single computing device 120 (see FIG. 18).

The external service processor 40 includes one or more content file sharing services. For example, the external service processor 40 may include a picture sharing service 41, a video sharing service 42, a music sharing service 43, and the like. The external service processor 40 may include other services such as a map service 44, an e-payment or electronic transaction service 45, and a Short Message Service (“SMS”) Gateway 46. As is appreciated by those of ordinary skill in the art, the external service processor 40 may be configured to provide additional services beyond those described herein.

The picture sharing service 41 includes any web-based service, such as Flickr, that allows users to share images, such as photographs, with one another. The video sharing service 42 includes any web-based service, such as YouTube and Pandora TV, that allows users to share videos with one another. The music sharing service 43 includes any web-based service that allows users to share music with one another. The map service 44 includes any web-based service, such as Microsoft Virtual Earth, Google Map, Yahoo Map, Naver Map, and the like, that provides images of maps online. The electronic transaction service 45 enables electronic payments over the network 4. For example, the electronic transaction service 45 may be used to pay for products over the network 4. While all of these services have been described as provided by the external service processor 40, those of ordinary skill in the art appreciate that one or more of these services may be provided be separate processors and such embodiments are within the scope of the present teachings.

The web server 10 includes a data management module 11, a user account management module 12, an image processing module 13, a map processing module 14, and an SMS processing module 15. As is appreciated by those of ordinary skill in the art, the web server 10 may include additional software modules other than those described herein.

The storage device 20 includes a user account database 21, a product inventory database 22, an advertisement activation information database 23, a scrap storage location 24, an advertisement storage location 25, and a content storage location 26. The storage device 20 may include additional databases and storage locations beyond those described herein.

The user account database 21 stores user account information provided to it by the user account management module 12 of the web server 10. The user account information includes a user identification, password, mobile station telephone number, e-mail address, and the like. The product inventory database 22 stores product information related to a product (product name, actual price, sale price, etc.) provided to the product inventory database 22 by the data management module 11. The advertisement activation information database 23 stores advertisement activation information provided to the advertisement activation information database 23 by the data management module 11 of the web server 10. The scrap storage location 24 stores information about content objects the user has scrapped (described below) and stored for later use. The advertisement storage location 25 stores advertisement information (e.g., an advertisement identifier, an advertisement name, an advertisement image, an advertisement video, and the like) provided to the advertisement storage location 25 by the data management module 11 of the web server 10. The content storage location 26 stores any user created Rich Content items, and content (e.g., images, videos, etc.) uploaded by the user. The content storage location 26 associates user created and uploaded content with the user for later retrieval by the user.

The client computing device 30 includes a client program 31. When the client computing device 30 connects to the web server 10 over the network 4, the web server 10 causes the client computing device 30 to execute the client program 31, which is in communication with the modules 11-15 executing on the web server 10. As will be described in greater detail below, the client computing device 30 includes a processing unit 121 (see FIG. 18) coupled to a system memory 32 (see FIG. 18), on which the client program 31 is installed. When the client computing device 30 disconnects from the web server 10, execution of the client program 31 on the client computing device 30 may terminate.

While the client program 31 is described as implemented in a web browser, in alternate embodiments, the client program 31 may be implemented as a desktop application, or in other operating environments such as a PDA, a cellular telephone, etc. The client program 31 is not limited to being implemented in any particular operating environment.

The client program 31 includes content file sharing functions configured to interact with the content file sharing services provided by the external service processor 40. By way of a non-limiting example, the client program 31 illustrated includes a music processing module 311, a picture processing module 312, a video processing module 313, and the like. The music processing module 311, a picture processing module 312, a video processing module 313 also function as content file processing functions that upload content files from the system memory 32 of the client computing device 30 to the content storage location 26.

The client program 31 also includes an embedded code processing module 314, an advertisement processing module 315, e-commerce processing module 316, an asynchronous transmission module 317, a content rendering module 318, a content management module 319, a scrap management module 320, a content object generation module 321, a content transmission module 322, a content receiving module 323, an video/audio transmission module 324, an video/audio receiving module 325, a chat module 326, and an electronic chalkboard module 327.

The data management module 11 of the web server 10 searches the content storage location 26 for a Rich Content item requested by the content management module 319 (using e.g., a Rich Content identification number, title, last saved date/time, etc.) and delivers the Rich Content item to the content management module 319. After reading the Rich Content items located in the content storage location 26, the data management module 11 transmits the located Rich Content item to the content management module 319.

The Rich Content item includes information required by the content rendering module 318 to render or display the Rich Content item. For example, the Rich Content item includes one or more references (e.g., Uniform Resource Locators (“URLs”)) to content files stored in the content storage location 26. By way of a non-limiting example, the data management module 11 may transmit a Rich Content item to the content rendering module 318 having a URL of an uploaded picture, a URL of an uploaded video, and/or a URL of uploaded music. Each URL is a reference to a storage location of the storage device 20 whereat the content file (e.g., image, video, etc.) associated with the URL is stored. The content rendering module 318 uses the URLs to locate the content file associated therewith and display the Rich Content item. The Rich Content item includes additional information specified by the user who created the Rich Content item. For example, the Rich Content item may specify the location in which each of the content files is displayed, the size of the region in which each content file is displayed, color information, and the like.

The user account management module 12 receives the user account information and stores it in the user account database 21 of the storage device 20. When the user account management module 12 receives user account information from a user, the user account management module 12 accesses the user account database 21 to verify whether a user account associated with the user account information exists. The user account management module 12 also verifies whether the user has entered valid user account information for the purposes of logging the user onto the system 4.

The image processing module 13 stores an image downloaded from the picture sharing service 41 in the content storage location 26 and provides a URL associated with the image to the content rendering module 318. The content rendering module 318 may use the URL to access the image.

The map processing module 14 receives location information (e.g., longitude and latitude) and zoom level. Then, the map processing module 14 downloads an image file of a map corresponding to the location information from the map service 44 and stores it in the content storage location 26. The image file of the map may be in any file format, including JPEG format, PNG format, and the like. The map processing module 14 provides a URL associated with the map image file stored in the content storage location 26 to the content rendering module 318.

The SMS processing module 15 of the web server 10 connects to the SMS Gateway 46 periodically to determine whether a Multimedia Messaging Service (“MMS”) message has arrived. A mobile station 60 such as a mobile telephone or similar wireless communication device, having a camera 62 may be communicatively coupled to the SMS Gateway 46 by a wireless connection 64. The mobile station 60 may transmit MMS messages to the SMS Gateway 46 over the wireless connection 64.

For ease of illustration, the wireless connection 64 between the mobile station 60 and the SMS Gateway 46 has been illustrated as a direct connection; however, as is appreciated by those of ordinary skill in the art implementing the wireless connection 64 may include additional intervening components, some of which may be connected by wired connections. Further, the mobile station 60 may be connected by the wireless connection 64 to the network 4 and by the network 4 to the SMS Gateway 46. Methods of connecting a mobile station to an SMS Gateway are well known in the art and will not be explained in detail herein.

The user may transmit a photograph taken using the camera 62 coupled to the mobile station 60 in an MMS message to the SMS Gateway 46. The MMS message may be sent to a predetermined email address associated with the SMS Gateway 46 using any method known in the art for sending MMS messages from a mobile telephone.

Alternatively, the user may transmit the MMS message including the photograph to an identification number assigned previously to the SMS Gateway 46 and associated with the system 2. The MMS message may be transmitted over the wireless connection 64 by dialing the identification number and transmitting the MMS message using any method known in the art for sending MMS message from a mobile station. The identification number may include a five digit or six digit SMS short code, or a standard eleven digit international phone number (e.g., +14255822278).

The format of the MMS message includes header information and a body portion. The header information includes the telephone number of the mobile station that sent the MMS message. The body portion includes the photograph taken using the camera 62 coupled to the mobile station 60.

The SMS processing module 15 periodically connects to the SMS Gateway 46 and if a MMS message has arrived, analyzes the header information of the MMS message and extracts the telephone number of the mobile station that sent the MMS message. The telephone number is compared with the user account information (which includes a mobile station telephone number) stored in the user account management module 12 and used to identify a user identifier associated with the mobile station telephone number. Then, the body portion of the MMS message is analyzed, and the photograph is extracted and stored in the scrap storage location 24 associated with the user associated with the mobile station telephone number.

The music processing module 311 uses a music sharing service 43 to search for music using one or more keywords input by a user into a music search engine. The music processing module 311 may also upload any music files selected by the user stored on the system memory 32 of the client computing device 30 to the content storage location 26.

The picture processing module 312 uses a picture sharing service 41 to search for images using one or more keywords input by a user into an image search engine. The picture processing module 312 may also upload any image files selected by the user stored on the system memory 32 of the client computing device 30 to the content storage location 26.

The video processing module 313 uses a video sharing service 42 to search for videos using one or more keywords input by a user into a video search engine. The video processing module 313 may also upload any video files selected by the user stored on the system memory 32 of the client computing device 30 to the content storage location 26.

The embedded code processing module 314 is configured to receive a segment of computer code or instructions generated by a third party service and identify which third party service generated the code. Further, the embedded code processing module 314 may determine which type of content (e.g., image, video, music, etc.) is associated with the third party service. For example, if the embedded code processing module 314 determines the segment of code was generated by YouTube, the embedded code processing module 314 determines YouTube is associate with video type content and transmits the segment of code to the video processing module 313. The video processing module 313 extracts a unique video identifier associated with a video from the segment of code, and requests and receives information associated with the video identifier (e.g., a thumbnail image of the video, video name, etc.) from the video sharing service 42.

The advertisement processing module 315 receives the results of a search of the advertisement storage location 25 for advertisements available to the user from the data management module 11. The results are displayed to the user who selects one of the advertisements. The advertisement processing module 315 sends the unique advertisement identifier of the selected advertisement to the web server 10. The advertisement processing module 315 also sends advertisement activation information (described below) to the web server 10.

The e-commerce processing module 316 displays product information (e.g., names, unique product identifiers, etc.) related to products available to the user received from the data management module 11. The product information may be displayed in a list format. When the user selects a product, the unique product identifier of the selected product is transmitted to the data management module 11. The data management module 11 extracts additional product information (e.g., actual price, sale price, etc.) related to the selected product from the product inventory database 22 and transmits the additional product information to the e-commerce processing module 316.

The asynchronous transmission module 317 enables asynchronous transmission so a user does not have to wait for upload operations to be completed when transmitting images, videos, music, and the like selected for uploading from the system memory 32 of the client computing device 30 to the content storage location 26.

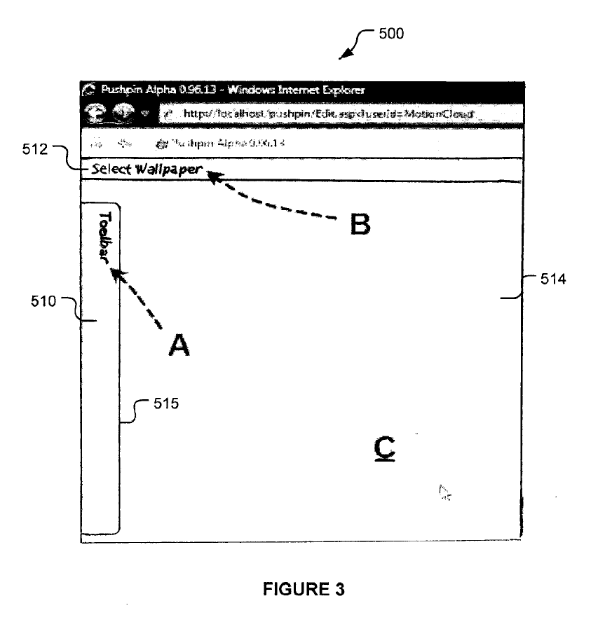

The content rendering module 318 renders the Rich Content item for display to the user in an editing region 514 of a Rich Content editing page or screen 500 (see FIG. 3). The content rendering module 318 is used to render the Rich Content item when it is created and edited. Optionally, the content rendering module 318 may also be used to preview the Rich Content item in its final form displayable on a website. The content rendering module 318 receives URLs associated with uploaded content files (e.g., image files, video files, music files, and the like) from the data management module 11, downloads the content files from the content storage location 26 using the URLs, and displays the downloaded content files in an editing region 514 of a Rich Content editing page or screen 500 (see FIG. 3).

The content management module 319 requests Rich Content information (e.g., the identification number of the Rich Content, title, and last saved date/time information) related to one or more Rich Content items stored in the content storage location 26 from the web server 10. After receiving the Rich Content information, the content management module 319 transmits the identification number of a selected Rich Content item to the web server 10. The web server 10 transmits the Rich Content item having the identification number to the content management module 319, which displays it in the editing region 514 (see FIG. 3) using the content rendering module 318. The web server 10 may transmit the Rich Content item to the content management module 319 in XML format.

The scrap management module 320 requests information related to content files stored by the user in the scrap storage location 24 from the data management module 11. After receiving the information related to the content files, the scrap management module 320 displays the information to the user. By way of a non-limiting example, the scrap management module 320 may receive the information in XML format and display the information in a list (not shown).

The content object generation module 321 generates a content object that has basic or default attributes in the editing region 514 of the Rich Content editing screen 500 (see FIG. 3). Different types of content and content files may be displayed using different types of content objects. For example, image files may be displayed using image type content objects, video files may be displayed using video type content objects, music files may be displayed using music type content objects, and so forth.

The content transmission module 322 classifies the user as a Broadcaster and sends a request to the broadcast server 50 requesting the generation of a broadcast channel. The content transmission module 322 also transmits data (e.g., content) over the broadcast channel during a broadcast. The broadcast channel may provide communication between the Broadcaster and one or more viewer. The content receiving module 323 receives data (e.g., content) transmitted over the broadcast channel during a broadcast.

The video/audio transmission module 324 executes encoding operations on the image and/or audio signals generated by the Broadcaster (or a viewer) using a video camera (e.g., a Webcam) and/or Microphone. The video/audio transmission module 324 may use any CODEC, including MPEG, H.264, and the like. The video/audio transmission module 324 transmits the encoded video and/or audio signals over the broadcast channel.

The video/audio receiving module 325 receives the encoded video and/or audio signals transmitted over the broadcast channel, and decodes them (e.g., through a CODEC such as MPEG or H.264). Then, the video/audio receiving module 325 displays any decoded video signals on the display unit 147 (see FIG. 18) and outputs any decoded audio signal through the speaker(s) (not shown).

The chat module 326 provides a text chat between the Broadcaster and the viewer. Methods of implementing text chats are well known in the art and will not be described herein.

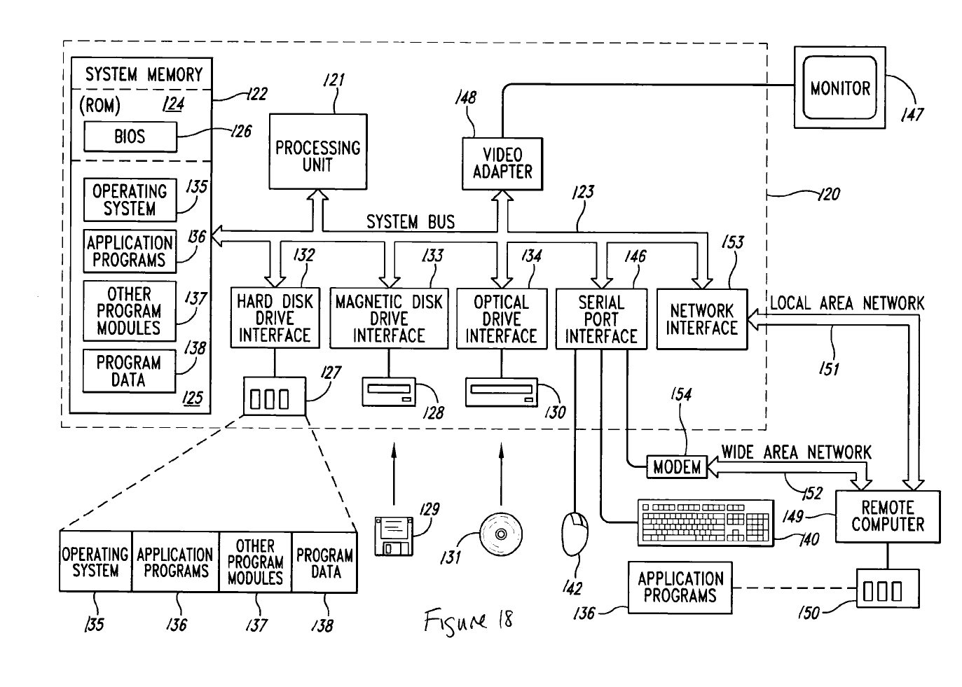

The electronic chalkboard module 327 implements an electronic whiteboard or chalkboard (e.g., a Rich Content editing region 772 illustrated in FIG. 16 and described below) upon which the Broadcaster and/or viewer may draw and/or write. The Broadcaster and/or viewer may use the electronic chalkboard to draw and/or write content with various colored pens in real time. Further, content objects may be inserted into the electronic chalkboard for display. The Broadcaster and/or viewer may draw and/or write on the content object using the colored pens in real time.

The broadcast server 50 includes a channel management module 51, and a relay or broadcast module 52. The channel management module 51 receives a request for a broadcast channel from the content transmission module 322. In response to the request, the channel management module 51 classifies the user as a Broadcaster, and generates a new broadcast channel. The channel management module 51 also displays any broadcast channels generated to users of the system 2. When Peer-to-Peer (“P2P”) communication between the Broadcaster and one or more of the viewers over the broadcast channel is not possible, the relay or broadcast module 52 transmits the data between the Broadcaster and the viewers.

### Method

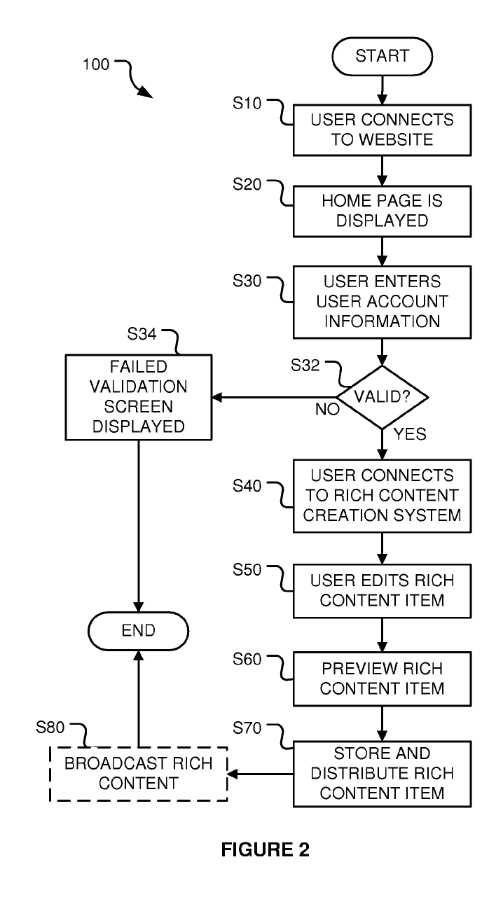

FIG. 2 is flow diagram of a method 100 performable by the system 2 (see FIG. 1). In first block S10, a user connects to a website having a main or home page (not shown) configured to allow the user to register to use the system 2 or allow a previously registered user to log onto the system 2. In this block, the client program 31 may be downloaded to the client computing device 30 from the web server 10, stored in the system memory 122 (see FIG. 18) of the client computing device 30 and executed by the processing unit 121. In block S20, the home page (not shown) is displayed to the user on the display unit 147 (see FIG. 18) of the client computing device 30.

Next, in block S30, the user registers with the system 2 by entering user account information (e.g., login information, payment information, etc.) used to create a user account associated with the user. If a user account associated with the user already exists, the user enters only the login information (e.g., user identifier and password).

In decision block S32, the system 2 validates the user using the account information provided in block S30. If the system 2 determines the user account information is invalid, the decision in decision block S32 is “NO,” and in block S34, a failed validation screen (not shown) is displayed to the user on the display unit 147. Otherwise, if the decision in decision block S32 is “YES,” in block S40, a connection is made to the system 2 and the Rich Content editing screen 500 (see FIG. 3) is displayed to the user on the display unit 147.

Next, in block S50, the user edits a Rich Content item using the Rich Content editing screen 500. Then, in block S60, the Rich Content item created may be previewed or tested.

Next, in block S70, the completed Rich Content item is stored in the storage device 20 and distributed to a target medium. By way of a non-limiting example, the Rich Content item may be distributed to a target medium by first generating a computer readable equivalent of the Rich Content item (e.g., a segment of embeddable code (e.g., HTML) operable to generate a display substantially equivalent to the Rich Content item in an Internet Browser application) and copying and pasting the computer readable equivalent in an appropriate location (e.g., on a website).

In optional block S80, a broadcast channel may be generated and Rich Content broadcast in real time over the network 4 (e.g., the Internet). Then, the method 100 terminates.

### User Interface Components

FIGS. 3-17 provide exemplary user interface components that may be displayed to the user on the display unit 147 of the client computing device 30 by the client program 31. The client program 31 uses the user interface displays to perform seven functions: (1) a user registration function; (2) a user login function; (3) a Rich Content editing function; (4) a preview function; (5) a distribute function; (6) a broadcast function; and (7) a watch function.

1. User Registration Function

After the user connects to the web server 10, the client program 31 begins executing and displays the home page (not shown) to the user. The home page displays a registration control (e.g., a button, a hyperlink, and the like) to the user. The user initiates registration with the system 2 by selecting and actuating the registration control.

Actuation of the registration control causes the client program 31 to display a user account creation page or screen (not shown). The user account creation screen includes text input regions into which the user provides user account information, such as a user identifier, password, email address, shipping address, residential address, mobile station telephone number, credit card information, and the like. A user who would like to create a user account enters the user account information into the text input regions and transmits that information to the web server 10 of the system 2. The user account management module 12 of the web server 10 receives the user account information. If the user account information is valid, the user account management module 12 of the web server 10 saves the user account information in the user account information storage 21. Otherwise, the user account management module 12 instructs the client program 31 to display the failed validation screen (not shown) to the user on the display unit 147.

2. User Login Function

After the user connects to the web server 10, the client program 31 begins executing and displays the home page (not shown) to the user. The home page displays a login control (e.g., a button, a hyperlink, and the like) to the user. The user initiates a login with the system 2 by selecting and actuating the login control.

Actuation of the login control causes the client program 31 to display a user login page or screen (not shown). The login screen has text input regions for user account login information, such as a user identifier and password. A user with a user account enters a user identifier and password into the text input regions.

The client program 31 transmits the user account information to the web server 10. The user account management module 12 of the web server 10 receives the user account information and determines whether a user account associated with the user account information exists by querying the user account database 21 of the storage device 20 for the user account information. If the user account exists, and the user identifier and password are valid, the user is logged onto the system 2. Otherwise, the client program 31 displays the failed validation screen (not shown) to the user on the display unit 147.

3. Rich Content Editing Function

Referring to FIGS. 1 and 3, after successfully logging onto the system 2, the client program 31 displays the Rich Content editing screen 500 to the user on the display unit 147.

The Rich Content editing screen 500 has three sections “A,” “B,” and “C.” The first section “A” includes a toolbar 510. The second section “B” includes a select wallpaper function 512. The third section “C” includes an editing region 514 for adding, modifying, and positioning content objects (for example, pictures, videos, texts, etc.).

The toolbar 510 and/or the select wallpaper function 512 may be at least partially hidden to allow more display space the editing region 514. The toolbar 510 and/or the select wallpaper function 512 may be configured to be fully displayed when selected (e.g., when the mouse is placed over the partially displayed toolbar 510 or select wallpaper function 512). For example, only half of the toolbar 510 may be displayed, the other half of the toolbar 510 being hidden. Thus, the toolbar 510 has a displayed portion 515 and a hidden portion (not shown). When the mouse cursor is placed over the displayed portion of the toolbar 510, the hidden portion may appear on the screen. The hidden portion may be displayed in an animated manner (e.g., sliding motion) that makes the toolbar 510 appear to move or slide into view. When the mouse cursor is moved outside of the toolbar 510, the previously hidden portion of the toolbar 510 may again be hidden.

Turning to FIG. 3, the select wallpaper function 512 is used to select a wallpaper image or background displayed within the editing region 514. The selected image may be scaled to fill the entire editing region 514. Alternatively, the selected image may be tiled within the editing region 514. As mentioned above, only a portion of the select wallpaper function 512 may be displayed. When the mouse cursor is positioned on the displayed portion, the select wallpaper function 512 may be displayed completely. When the mouse cursor is moved outside of the select wallpaper function 512, the previously hidden portion of the select wallpaper function may again be hidden.

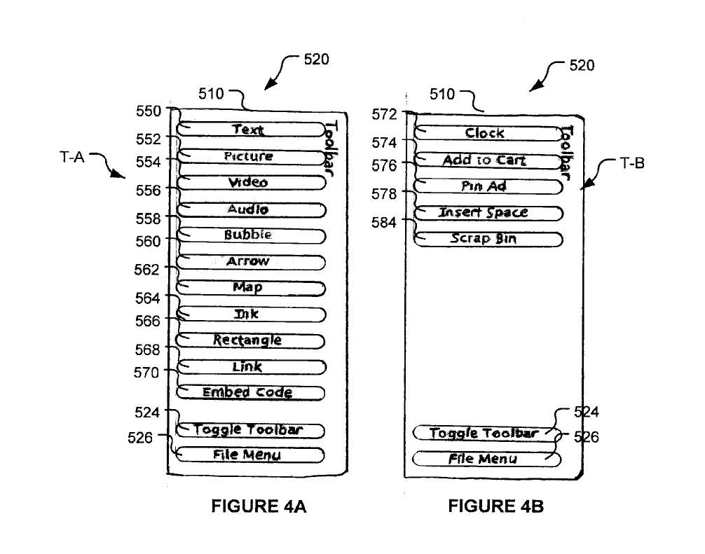

Referring to FIGS. 4A and 4B, the toolbar 510 includes a plurality of controls 520, which include controls used to add, position, and edit content objects in the editing region 514. When the toolbar 510 is displayed completely, the user can select desired controls 520. The controls 520 may include a toggle control 524 that may be used to toggle the contents of the toolbar 510 displayed. For example, the toggle control 524 may toggle the contents of the toolbar 510 between a first set of controls “T-A” (see FIG. 4A) and a second set of controls “T-B” (see FIG. 4B). In this manner, more controls may be displayed within the limited amount of space allocated to the toolbar 510.

Turning to FIGS. 3 and 4A, the controls 520 of the toolbar 510 may include a text control 550 used to insert a text type content object in the editing region 514. When the user clicks on the text control 550, the content generation module 321 generates a text type content object with basic (or default) attributes in the editing region.

The controls 520 may include an image control 552 used to insert an image located using the picture sharing service 41 or stored on the system memory 32 of the client computing device 30 in a particular location within the editing region 514. When the user clicks on the image control 552, the content object generation module 321 generates one image type content object with basic or default attributes in the editing region 514.

The controls 520 may include a video control 554 used to insert a video located using the video sharing service 42 or stored on the system memory 32 of the client computing device 30 in a particular location within the editing region 514. When the user clicks on the video control 554, the content object generation module 321 generates one video type content object with basic or default attributes in the editing region 514.

The controls 520 may include an audio or music control 556 used to insert a music type content item configured to playback music located using the music sharing service 43 or stored on the system memory 32 of the client computing device 30 in a particular location within the editing region 514. When the user clicks on the music control 556, the content object generation module 321 generates one audio type content object with basic or default attributes in the editing region 514.

The controls 520 may include a speech bubble control 558 used to insert a bubble type content object in the editing region 514. When a user clicks on the speech bubble control 558, the content object generation module 321 generates one bubble type content object with basic or default attributes in the editing region 514.

The controls 520 may include an arrow control 560 used to insert an arrow type content object pointing to a particular region of the editing region 514. When a user clicks on the arrow control 560, the content object generation module 321 generates one arrow type content object with basic or default attributes in the editing region 514.

The controls 520 may include a map control 562 used to insert a map type content object in the editing region 514. When a user clicks on the map control 562, the content object generation module 321 generates one map type content object with basic or default attributes in the editing region 514.

The controls 520 may include an ink control 564 used to insert an ink type content object in the editing region 514. The ink type content object displays handwritten text or hand drawn images (“ink”) input into the client computing device 30 using a stylus, mouse, and/or pen. When a user clicks on the ink control 564, the content object generation module 321 generates one ink type content object with basic or default attributes in the editing region 514.

The controls 520 may include a rectangle control 566 used to insert a rectangle type content object in the editing region 514. When a user clicks on the rectangle control 566, the content object generation module 321 generates one rectangle type content object with basic or default attributes in the editing region 514.

The controls 520 may include a hyperlink control 568 used to insert a hyperlink type content object in the editing region 514. When a user clicks on the hyperlink control 568, the content object generation module 321 generates one hyperlink type content object with basic or default attributes in the editing region 514.

The controls 520 may include an embedded code control 570 used to insert an embedded code type content object in the editing region 514. The embedded code type content object is used to insert and execute an outside function provided by a third party service in the editing region 514. For example, the embedded code type content object can be used to insert a video stored on YouTube. When a user clicks on the embedded code control 570, the content object generation module 321 generates one embedded code type content object with basic or default attributes in the editing region 514.

Turning to FIGS. 3 and 4B, the controls 520 may include a clock control 572 used to insert a clock type content object in the editing region 514. When a user clicks on the clock control 572, the content object generation module 321 generates one clock type content object with basic or default attributes in the editing region 514.

The controls 520 may include an add-to-cart control 574 used to insert a purchasing object or an add-to-cart type content object in the editing region 514. The add-to-cart type content object includes information related to a product offered for sale and may be linked to the product inventory database 22. If a buyer selects (e.g., clicks on) the add-to-cart type content object displayed in the final medium, a request to purchase the product (including a product identifier) is forward to a transaction page (not shown) provided by the electronic transaction service 45. The buyer is directed to the transaction page to continue the transaction. At the buyer's option, the buyer may complete the transaction by purchasing the product on the transaction page. When a user clicks on the add-to-cart control 574, the content object generation module 321 generates one add-to-cart type content object with basic or default attributes in the editing region 514.

The controls 520 may include a submit or checkout control (not shown) used to insert a purchase indicator or checkout type content object in the editing region 514. In particular implementations, when a buyer clicks on an add-to-cart type content object displayed in the final medium, instead of being directed to a transaction page, the add-to-cart type content object stores an indication of buyer's desire to purchase a product associated with the add-to-cart type content object. In this manner, more than one add-to-cart type content object may be selected (e.g., clicked on) before the buyer is directed to the transaction page (not shown) provided by the electronic transaction service 45. When the buyer clicks on the checkout type content object displayed in the final medium, a purchase request is sent to the transaction page. The purchase request identifies each of the products associated with add-to-cart type content objects selected by the buyer. When a user clicks on the checkout control, the content object generation module 321 generates one checkout type content object with basic or default attributes in the editing region 514.

The controls 520 may include a pin ad control 576 used to insert an advertisement type content object in the editing region 514. The advertisement type content object displays an advertisement in the editing region 514. The advertisement displayed is chosen by the user from an advertisement inventory stored in the advertisement storage location 25. The user may manually select any suitable advertisement. The advertisement type content object may be positioned and displayed anywhere in the editing region 514.

When a user clicks on the pin ad control 576, the content object generation module 321 generates one advertisement type content object with basic or default attributes in the editing region 514. Then, the advertisement processing module 315 requests the advertisement information for any advertisements stored in the advertisement storage location 25 from the web server 10. The data management module 11 receives the request, searches the advertisement storage location 25 for advertisements available to the user, and delivers the search results to the advertisement processing module 315. The advertisement processing module 315 displays any advertisements located by the search to the user on the display unit 147. By way of a non-limiting example, the advertisements located may be displayed in a list or advertisement inventory from which the user may select an advertisement to be displayed by the advertisement type content object.

After the user selects an advertisement from the advertisement inventory, the advertisement processing module 315 delivers the unique advertisement identifier of the selected advertisement to the web server 10. At the web server 10, the receiving data management module 11 extracts advertisement information for the selected advertisement associated with the received advertisement identifier from the advertisement storage location 25. The data management module 11 delivers the advertisement information to the advertisement processing module 315. The object generation module 321 displays at least a portion of the advertisement information in the advertisement type content object in the editing region 514.

After the Rich Content is distributed to a final medium and is displayed to a consumer on a display unit 147, the consumer may activate the advertisement type content object (e.g., by clicking on it). When activated, the advertisement type content object plays back any video and/or audio associated with the advertisement type content object. After the advertisement type content object is activated, the advertisement processing module 315 transmits advertisement activation information to the web server 10. By way of non-limiting examples, the advertisement activation information may include the identity of the consumer, when the consumer activated the advertisement type content object, and which advertisement was displayed by the advertisement type content object. The receiving data management module 11 records the advertisement activation information in the advertisement activation information database 23.

In some embodiments, if the consumer positions the mouse cursor over the advertisement type content object, an optional visit button (not shown) may be displayed that may be clicked to direct the consumer to a website related to the advertisement displayed by the advertisement type content object. If the consumer clicks the visit button, the advertisement processing module 315 transmits advertisement activation information to the web server 10. At the web server 10, the receiving data management module 11 records the advertisement activation information in the advertisement activation information database 23. Next, the advertisement processing module 315 directs the user to the website related to the advertisement displayed by the advertisement type content object. The advertisement processing module 315 records whether purchase was made and other important actions taken at the website related to the advertisement in the advertisement activation information database 23.

If the consumer positions the mouse cursor over the advertisement type content object, an optional stop button (not shown) may be displayed that when clicked terminates playback of the advertisement by the advertisement type content object.

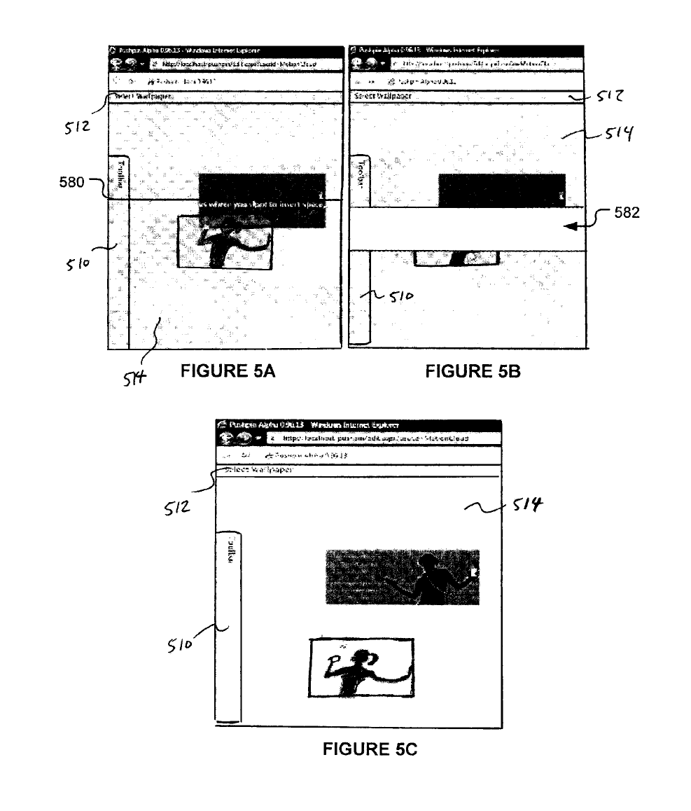

The controls 520 may include an insert space control 578 used to insert space between the content objects displayed in the editing region 514. Referring to FIG. 5A, after a user clicks on the insert space control 578, the user selects a location in the editing region 514 by clicking in the editing region 514, depressing and holding the left mouse button. A horizontal line 580 is defined at the location were the left mouse button was clicked that extends across the editing region 514. Referring to FIG. 5B, the user moves the mouse cursor down while the left mouse button is depressed to indicate an amount of space 582 to be inserted below the horizontal line 580 in the editing region 514. As long as the user continues to depress the left mouse button, the user may adjust the amount of space 582 to be inserted below the horizontal line 580 by moving the mouse cursor up and down within the editing region 514. If the mouse cursor is moved above the horizontal line 580, the amount of space 582 to be inserted goes to zero.

Referring to FIG. 5C, when the user releases the left mouse button, the size of the editing region 514 is increased by the amount of space 582 to be inserted and any content objects in the editing region 514 below the horizontal line 580 are moved down by the amount of space inserted along the horizontal line 580. Any content objects in the editing region 514 above the horizontal line 580 remain in their original locations unaffected. Content objects intersected by the horizontal line 580 are identified as above or below the horizontal line 580 and processed accordingly. In this manner, the user selects a first y-coordinate in the editing region 514 by clicking and holding the left mouse button (see FIG. 5A) and a second y-coordinate in the editing region 514 by releasing the left mouse button after moving the mouse cursor vertically within the editing region 514. The amount of space 582 to be inserted is equal to the difference between the second y-coordinate and the first y-coordinate.

Returning to FIGS. 3 and 4B, the controls 520 may include a scrap bin control 584 used to insert a content object in the editing region 514. The scrap storage location 24 is used to store content files (e.g., image files, video files, text files, and the like) “scrapped” while browsing the Internet. Additionally, photographs taken by the user using camera 62 of the mobile station 60 and transmitted to the system 2 may be stored in the scrap storage location 24. When the user clicks on the scrap bin control 584, the scrap management module 320 sends a request to the web server 10 requesting a list of available content files previously scrapped by the user. The receiving data management module 11 queries the scrap storage location 24 for content files previously scrapped by the user and delivers the query results to the scrap management module 320. The scrap management module 320 displays the scrapped content files to the user using the display unit 147. By way of a non-limiting example, the scrapped content may be displayed in a list and may be transmitted as XML data. After the user selects a content file, the content object generation module 321 generates a content object of the appropriate type (e.g., a text type content object, an image type content object, a video type content object, etc.) in the editing region 514.

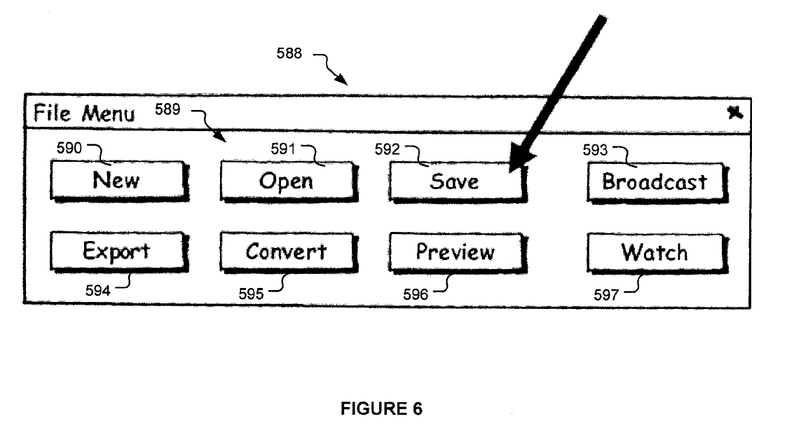

Referring to FIGS. 4B and 6, the controls 520 of the toolbar 510 may include a file menu control 526 that when activated displays a file menu 588 including a plurality of file controls 589, such as a new item control 590, open item control 591, save item control 592, broadcast control 593, export control 594, convert control 595, preview control 596, and watch control 597. The file menu control 526 is used to transition between five modes. The first mode is an edit mode, in which Rich Content is created in the editing region 514 (see FIG. 3). The second mode is a preview mode in which Rich Content created in the edit mode may be previewed by the user in its finalized distributable form. The third mode is a distribution mode in which the Rich Content is converted into a distributable segment of embeddable code. The fourth mode is an optional broadcast mode, which may be used as means of communication between a Broadcaster and at least one viewer. The fifth mode is an optional broadcast viewing mode in which a viewer connects to a broadcast channel previously opened or generated by a Broadcaster.

When the new item control 590 is activated, all of the content objects displayed in the editing region 514 (see FIG. 3) are removed therefrom and the user is able to create a new Rich Content item in the empty editing region.

Referring to FIGS. 1 and 6, if the open item control 591 is activated, the content management module 319 sends a request to the web server 10 requesting Rich Content information related to any Rich Content items associated with the user. The Rich Content information may include a Rich Content identification number, title, last saved date/time, and the like. The data management module 11 searches for the requested Rich Content information in the content storage location 26 and delivers any located to the content management module 319. The content management module 319 displays this information to the user. By way of a non-limiting example, the Rich Content information may be displayed in a Rich Content list.

After the user selects a Rich Content item from the Rich Content list, the content management module 319 transmits the Rich Content identification number of the selected item to the web server 10. At the web server 10, the data management module 11 locates the Rich Content item associated with the received Rich Content identification number in the content storage location 26, and transmits the stored Rich Content item to the content management module 319. The content management module 319 analyzes the Rich Content item (which may be in XML format) and displays the Rich Content item in the editing region 514 using the content rendering module 318.

### Editing Content Objects within the Editing Region

Returning to FIG. 3, the editing region 514 may include a first scroll bar (not shown) configured to scroll (left to right) along the x-axis and a second scroll bar (not shown) configured to scroll (up and down) along the y-axis.

The editing region 514 may be configured to support multiple editing layers positioned within three-dimensional space. Content objects are positioned by the user within the three-dimensional space of the editing region 514. Within the editing region 514, an x-axis, y-axis, and z-axis are defined. Accordingly, all of the content objects positioned inside the editing region 514 are assigned a z-index value on the z-axis. Content objects having lower z-index values appear beneath content objects having higher z-index values. For example, if the z-index value assigned to a content object named “Bubble 1” is 10 and the z-index value assigned to a content object named “Bubble 2” is 1, Bubble 2 will appear behind Bubble 1 in the editing region 514. As will be explained below, the z-index value of each content object in the editing region 514 can be specified by the user. Methods of laying content objects are known in the art and will not be described in detail herein.

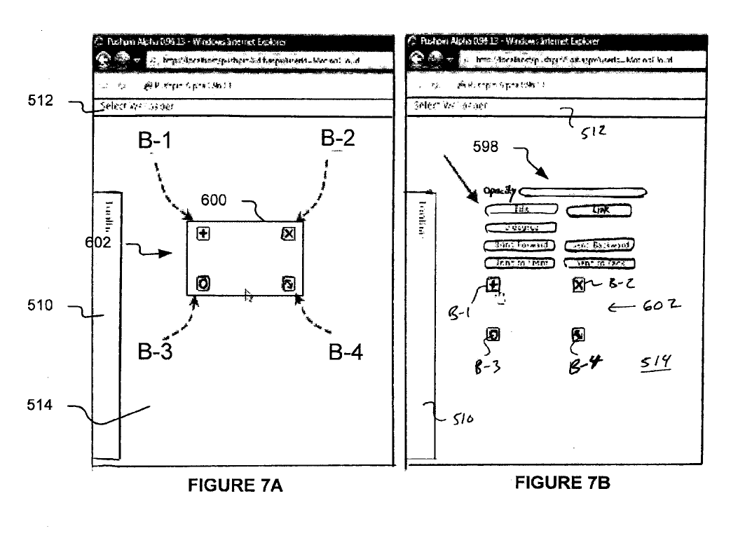

In prior art content editing tools, to select a content object, the user has to click on the content object using a mouse. Referring to FIG. 7A, within the editing region 514, the user may select a content object 600 by simply positioning the mouse cursor over the content object. Once the content object 600 is selected, a basic menu 602 for the selected content object is automatically displayed. When the mouse cursor is placed outside of the selected content object 600, the selected content object is automatically deselected. Thus, a mouse click is not required for selecting and/or deselecting a content object.

The basic menu 602 of the selected content object includes controls “B-1,” “B-2,” “B-3,” and “B-4” configured to operate on the selected content object 600. By way of a non-limiting example, the controls “B-1,” “B-2,” “B-3,” and “B-4” of the basic menu 602 may include a style menu button “B-1,” a remove button “B-2,” a rotate button “B-3,” and a resize button “B-4.” The basic menu 602 may also include a move button (not shown) and any other suitable controls known in the art.

Referring to FIG. 7B, when the style menu button “B-1” is actuated, a style menu 598 for the selected content object 600 is displayed. The shape and content of the style menu 598 may vary depending upon the type of the selected content object 600 (for example pictures, videos, text, etc.).

The selected content object 600 may be removed from the editing region 514 by clicking on the remove button “B-2” with the left mouse button, thereby activating the remove button.

The selected content object 600 may be rotated within the editing region 514 by holding down the left mouse button on the rotate button “B-3,” thereby activating the rotate button. After the rotate button “B-3” is activated, the rotational orientation of the selected content object 600 may be changed by moving the mouse cursor to rotate the content object to the left or right. When the selected content object 600 is in the desired rotational orientation, the left mouse button is released.

The selected content object 600 may be resized or scaled within the editing region 514 by holding down the left mouse button on the resize button “B-4,” thereby activating the resize button. After the resize button “B-4” is activated, the size of the selected content object 600 may be changed by moving the mouse cursor to grow or shrink the content object. When the selected content object 600 is of the desired size, the left mouse button is released.

The selected content object 600 may be positioned within the editing region 514 by holding down the left mouse button when the mouse cursor is positioned on the selected content object, dragging the selected content object 600 to a desired location, and releasing the left mouse button to drop the content object 600.

### Text Type Content Object

Referring to FIG. 8, when the selected content object 600 is a text type content object 608, the style menu 598 includes an edit button 610, a hyperlink button 612, a zero degree button 614, a bring forward button 616, a send backward button 618, a bring to front button 620, a send to back button 622, and an opacity control 624.

When the edit button 610 is clicked, a text edit screen or window (not shown) appears. Text can be entered into the text edit screen and the size, shape, color, etc. of the text can be modified. After the user has finished editing the text, the text type content object 608 is modified to reflect the edits.

When the hyperlink button 612 is clicked, the user may associate a URL with the text type content object 608 so that when the content consumer clicks on the text type content object 608, the website associated with the URL is displayed in the consumer's web browser. After the desired URL is entered by the user, optionally, the enter key may be pressed to display the webpage associated with the URL entered for the purposes of previewing the website.

The zero degree button 614 sets the rotational orientation (or angle) of the text type content object 608 to zero degrees, thereby returning the text type content object to an upright orientation.

The bring forward button 616 moves the text type content object 608 forward (e.g., by one layer) with respect to the z-axis (i.e., increases the z-index value of the text type content object). The send backward button 618 moves the text type content object 608 backward (e.g., by one layer) with respect to the z-axis (i.e., decreases the z-index value of the text type content object). The bring to front button 620 moves the text type content object 608 to the very front with respect to the z-axis and the send to back button 622 moves the text type content object 608 to the very back with respect to the z-axis.

The opacity control 624 controls the opacity of the text and may be implemented as a conventional slider control.

When the resize button “B-4” is used to resize a text type content object 608, the text is automatically realigned to fit the modified size of the text type content object.

### Image Type Content Object

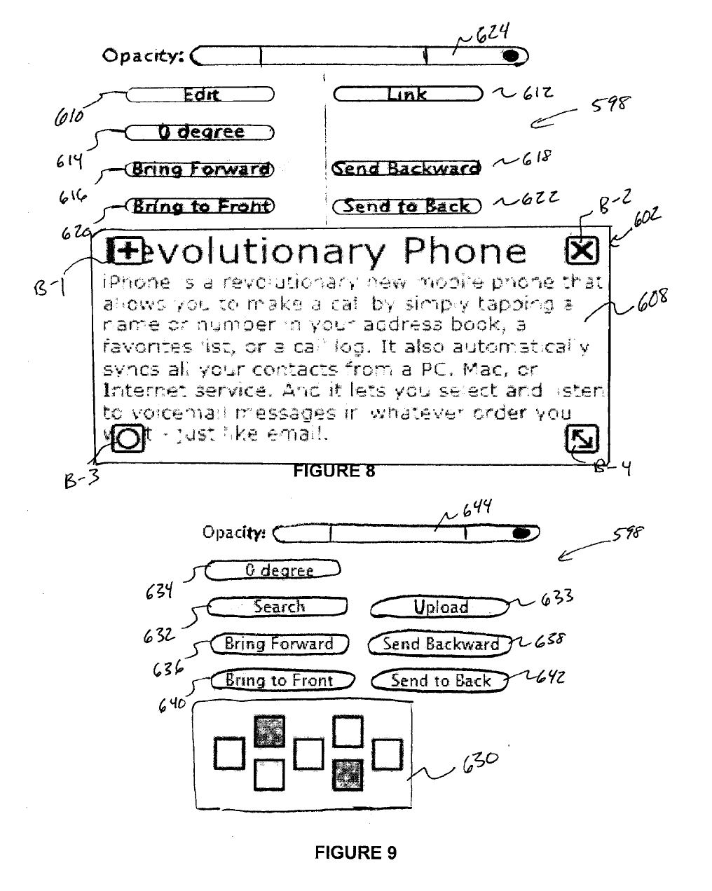

Referring to FIG. 9, when the selected content object 600 is an image type content object 630, the style menu 598 includes a search button 632, an upload button 633, a zero degree button 634, a bring forward button 636, a send backward button 638, a bring to front button 640, a send to back button 642, and an opacity control 644.

When the search button 632 is clicked, a conventional image search window (not shown) is displayed in which images can be searched using the picture sharing service 41 (see FIG. 1). For example, if the user inputs the keyword “iPod” in the image search window, the picture processing module 312 uses the picture sharing service 41 to search for an image associated with the keyword “iPod”. Information related to any images located by the search is displayed in the search window. After the user selects one of the images located by the search and optionally displayed in the search window, the content rendering module 318 modifies the image type content object 630 to display the selected image in the editing region 514.

When the upload button 633 is clicked, a list of image files stored in a predetermined location of the system memory 32 of the client computing device 30 is displayed. Then, the user selects an image from the list. The picture processing module 312 uploads the selected image from the system memory 32 of the client computing device 30 to the content storage location 26. The upload may occur asynchronously through the asynchronous transmission module 317. In such embodiments, the user may continue working without waiting for completion of the upload. When the selected image has finished uploading, the data management module 11 provides a URL associated with the uploaded image to the content rendering module 318, which downloads the image from the content storage location 26 using the URL, and modifies the image type content object 630 to display the image in the editing region 514.

The zero degree button 634 sets the rotational orientation (or angle) of the image type content object 630 to zero degrees, thereby returning the image type content object to an upright orientation.

The bring forward button 636 moves the image type content object 630 forward (e.g., by one layer) with respect to the z-axis (i.e., increases the z-index value of the image type content object). The send backward button 638 moves the image type content object 630 backward (e.g., by one layer) with respect to the z-axis (i.e., decreases the z-index value of the image type content object). The bring to front button 640 moves the image type content object 630 to the very front with respect to the z-axis and the send to back button 642 moves the image type content object 630 to the very back with respect to the z-axis.

The opacity button 644 controls the opacity of the image and may be implemented as a conventional slider control.

### Video Type Content Object

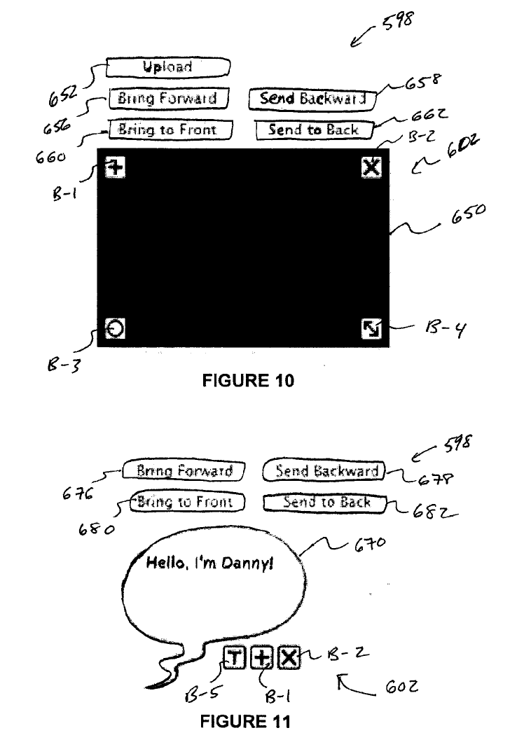

Referring to FIG. 10, when the selected content object 600 is a video type content object 650, the style menu 598 includes a search button (not shown), an upload button 652, a zero degree button (not shown), a bring forward button 656, a send backward button 658, a bring to front button 660, a send to back button 662, and an opacity control (not shown).

When the search button (not shown) is clicked, a conventional video search window (not shown) is displayed in which videos can be searched using the video sharing service 42. For example, if the user inputs the keyword “iPod” in the video search window, the video processing module 313 uses the video sharing service 42 to search for a video associated with the keyword “iPod.” Information related to any videos located by the search is displayed in the search window. After the user selects one of the videos located by the search, the content rendering module 318 modifies the video type content object 650 to display the selected video in the editing region 514.

When the upload button 652 is clicked, a list of video files stored in a predetermined location of the system memory 32 of the client computing device 30 is displayed. Then, the user selects a video from the list. The video processing module 313 uploads the selected video from the system memory 32 of the client computing device 30 to the content storage location 26. The upload may occur asynchronously through the asynchronous transmission module 317. In such embodiments, the user may continue working without waiting for completion of the upload. When the selected video has finished uploading, the data management module 11 provides a URL associated with the uploaded video to the content rendering module 318, which downloads the video from the content storage location 26 using the URL, and modifies the video type content object 650 to display the video in the editing region 514.

The zero degree button (not shown) sets the rotational orientation (or angle) of the video type content object 650 to zero degrees, thereby returning the video type content object to an upright orientation.

The bring forward button 656 moves the video type content object 650 forward (e.g., by one layer) with respect to the z-axis (i.e., increases the z-index value of the video type content object). The send backward button 658 moves the video type content object 650 backward (e.g., by one layer) with respect to the z-axis (i.e., decreases the z-index value of the video type content object). The bring to front button 660 moves the video type content object 650 to the very front with respect to the z-axis and the send to back button 662 moves the object 650 to the very back with respect to the z-axis.

The opacity control (not shown) controls the opacity of the video and may be implemented as a conventional slider control.

If the mouse cursor is placed over the video type content object 650 during playback of the video, a conventional video control panel is displayed. The control panel includes functions such as stop, play, full screen, volume control, and the like.

### Bubble Type Content Object

Referring to FIG. 11, when the selected content object 600 is a bubble type content object 670, the style menu 598 includes a change shape button (not shown), a zero degree button (not shown), a bring forward button 676, a send backward button 678, a bring to front button 680, and send to back button 682. The basic menu 602 may include the style menu button “B-1,” the remove button “B-2,” and a text button “B-5.”

When the text button “B-5” is clicked, a text box (not shown) is displayed. After text (e.g., “Hello, I′m Danny!”) is entered into the text box, the text is displayed in the bubble type content object 670. If the cancel button is pressed, the text entered into the text box is not displayed in the bubble type content object.

The change shape button (not shown) is used to change the shape of the bubble type content object.

The bring forward button 676 moves the bubble type content object 670 forward (e.g., by one layer) with respect to the z-axis (i.e., increases the z-index value of the bubble type content object). The send backward button 678 moves the bubble type content object 670 backward (e.g., by one layer) with respect to the z-axis (i.e., decreases the z-index value of the bubble type content object). The bring to front button 680 moves the bubble type content object 670 to the very front with respect to the z-axis and the send to back button 682 moves the bubble type content object 670 to the very back with respect to the z-axis.

Bubble type content objects may be overlaid atop other types of content objects, including image type content objects, map type content objects, and the like.

### Arrow Type Content Object

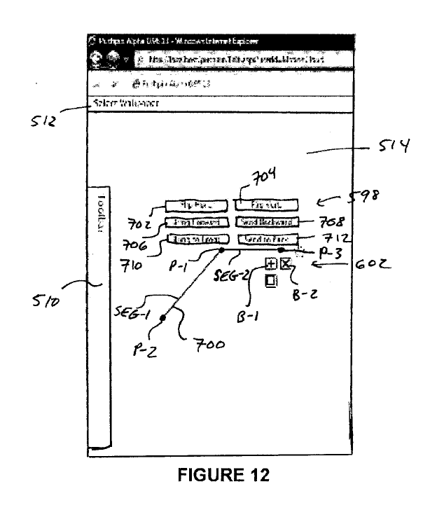

Referring to FIG. 12, when the selected content object 600 is an arrow type content object 700, the style menu 598 includes a flip horizontally button 702, a flip vertically button 704, a zero degree button (not shown), a bring forward button 706, a send backward button 708, a bring to front button 710, a send to back button 710, and an opacity control (not shown).

If the flip horizontally button 702 is clicked, the arrow type content object 700 is flipped horizontally. If the flip vertically button 704 is clicked, the arrow type content object 700 is flipped vertically.

The arrow type content object 700 has two line segments “SEG-1” and “SEG-2” connected at an intermediate point “P-1.” The arrow type content object 700 has a first end point “P-2” connected to one of the line segments “SEG-1” and “SEG-2” and a second end point “P-3” connected to the other of the line segments “SEG-1” and “SEG-2.” Each of the points “P-1,” “P-2,” and “P-3” are independently selectable by the mouse. The mouse may be used to select one of the points “P-1,” “P-2,” and “P-3” and drag it to another location thereby changing the shape of the arrow type content object 700.

The bring forward button 706 moves the arrow type content object 700 forward (e.g., by one layer) with respect to the z-axis (i.e., increases the z-index value of the arrow type content object). The send backward button 708 moves the arrow type content object 700 backward (e.g., by one layer) with respect to the z-axis (i.e., decreases the z-index value of the arrow type content object). The bring to front button 710 moves the arrow type content object 700 to the very front with respect to the z-axis and the send to back button 712 moves the arrow type content object 700 to the very back with respect to the z-axis.

Arrow type content objects may be overlaid atop other types of content objects, including image type content objects, map type content objects, and the like.

### Map Type Content Object

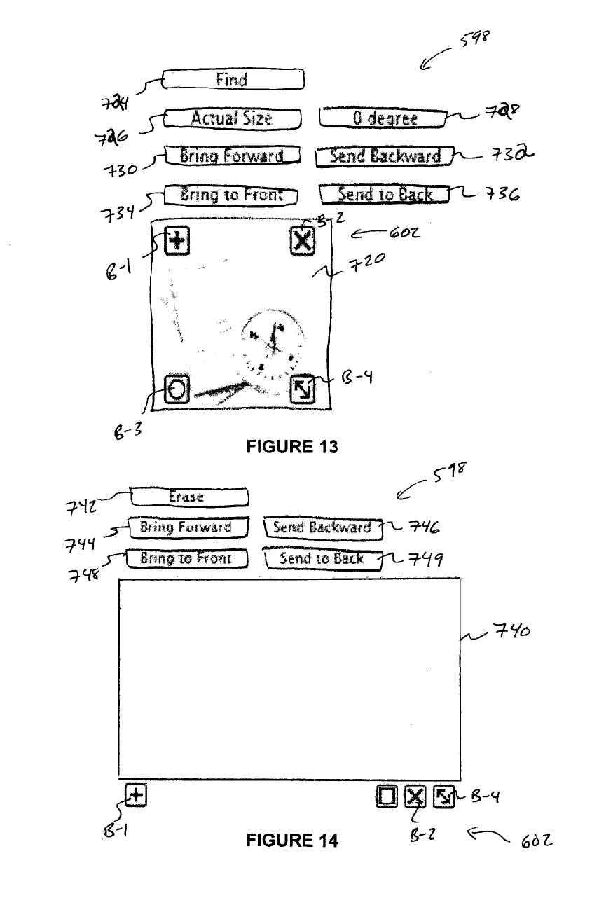

Referring to FIG. 13, when the selected content object 600 is a map type content object 720, the style menu 598 includes a find button 724, an upload button (not shown), an actual size button 726, a zero degree button 728, a bring forward button 730, a send backward button 732, a bring to front button 734, and a send to back button 736.

When the find button 724 is clicked, the content rendering module 318 connects to the map service 44, which displays a conventional map search engine type interface (“search window”). After the user inputs a search term, such as “New York,” in the search window, the content rendering module 318 searches for a location associated with the search term with the help of the map service 44 and displays a resulting map image on the display unit 147. The displayed image can be two-dimensional or three-dimensional. Further, the map image may be a satellite image.

After the user locates a desired map image, the user transmits map information related to the location returned by the map service 44 (such as longitude, latitude, zoom level, etc.) to the web server 10 by clicking an upload button (not shown). The map processing module 14 receives the map information, downloads the map image from the map service 44, and stores the map image in the content storage location 26. The map processing module 14 provides a URL associated with the map image to the content rendering module 318, which downloads the map image from the content storage location 26 using the URL, and modifies the map type content object 720 to display the map image in the editing region 514.

The zero degree button 728 sets the rotational orientation (or angle) of the map type content object 720 to zero degrees, thereby returning the map type content object to an upright orientation.

The actual size button 726 sets the size of the map type content object 720 to the actual size of the Map image.

The bring forward button 730 moves the map type content object 720 forward (e.g., by one layer) with respect to the z-axis (i.e., increases the z-index value of the map type content object). The send backward button 732 moves the map type content object 720 backward (e.g., by one layer) with respect to the z-axis (i.e., decreases the z-index value of the map type content object). The bring to front button 734 moves the map type content object 720 to the very front with respect to the z-axis and the send to back button 736 moves the map type content object 720 to the very back with respect to the z-axis.

### Ink Type Content Object

Referring to FIG. 14, when the selected content object 600 is an ink type content object 740, the style menu 598 includes an erase button 742, a bring forward button 744, a send backward button 746, a bring to front button 748, and a send to back button 749.

The erase button 742 erases all of the handwritten and hand drawn content (“ink”) input into the ink type content object.

The bring forward button 744 moves the ink type content object 740 forward (e.g., by one layer) with respect to the z-axis (i.e., increases the z-index value of the ink type content object). The send backward button 746 moves the ink type content object 740 backward (e.g., by one layer) with respect to the z-axis (i.e., decreases the z-index value of the ink type content object). The bring to front button 748 moves the ink type content object 740 to the very front with respect to the z-axis and the send to back button 749 moves the ink type content object 740 to the very back with respect to the z-axis.

### Rectangle Type Content Object

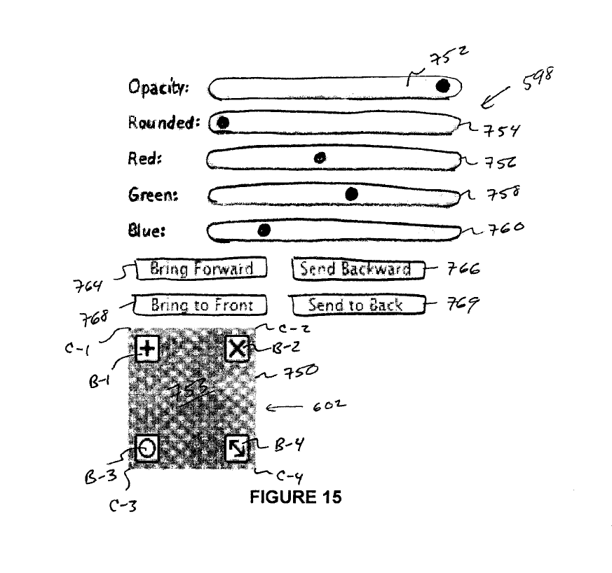

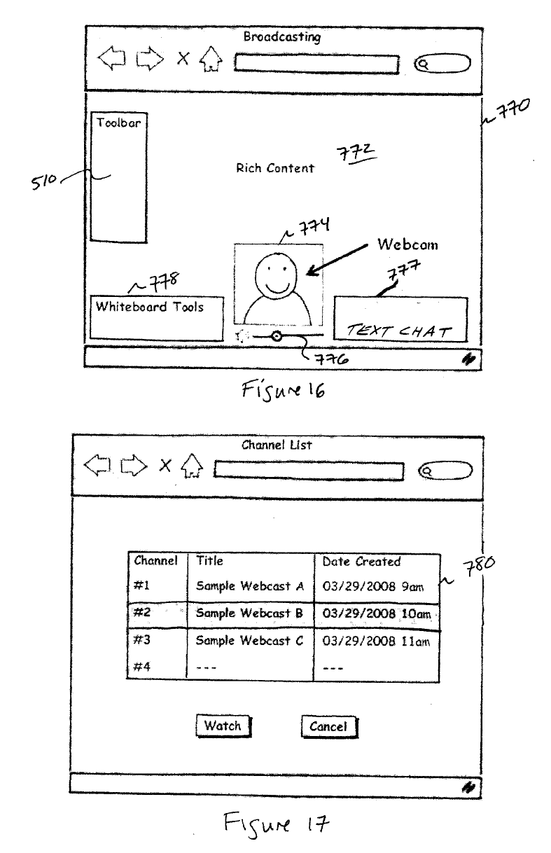

Referring to FIG. 15, when the selected content object 600 is a rectangle type content object 750, the style menu 598 includes an opacity control 752, a rounded control 754, a red control 756, a green control 758, a blue control 760, a bring forward button 764, a send backward button 766, a bring to front button 768, and a send to back button 769.

The opacity control 752 controls the opacity of the rectangle displayed and may be implemented as a conventional slider control.

The rectangle type content object 750 displays a rectangle 753 having four corners “C-1” to “C-4,” which default to right angle corners. The rounded control 754 determines an amount of rounding applied to the corners “C-1” to “C-4” of the rectangle.

The rectangle type content object 750 has a fill color. The red, green, and blue controls 756, 758, and 760 are used to determine the amount of red, green, and blue, respectively, in the fill color.

The bring forward button 764 moves the rectangle type content object 750 forward (e.g., by one layer) with respect to the z-axis (i.e., increases the z-index value of the rectangle type content object). The send backward button 766 moves the rectangle type content object 750 backward (e.g., by one layer) with respect to the z-axis (i.e., decreases the z-index value of the rectangle type content object). The bring to front button 768 moves the rectangle type content object 750 to the very front with respect to the z-axis and the send to back button 769 moves the rectangle type content object 750 to the very back with respect to the z-axis.

### Embedded Code Type Content Object

When the selected content object 600 is an embedded code type content object (not shown), the style menu 598 includes an embed button (not shown). When the embed button is clicked, an HTML input window is displayed. For example, to insert a video from YouTube in the editing region 514, a segment of embedded HTML code is input into the HTML input window. Optionally, a description of the embedded code type object may be entered into the HTML input window.

After the segment of embedded HTML code has been entered into the HTML input window, the embedded code processing module 314 determines which third party was used to create the embedded code. For example, if the embedded code was generated by YouTube, the embedded code processing module 314 transmits the embedded code to the video processing module 313. The video processing module 313 extracts a unique identifier of the video from the received information and requests and receives from the video sharing service 42 a thumbnail image and other information (e.g., video name, metadata, etc.) related to the video from the video sharing service 42. The content rendering module 318 modifies the embedded code type content object to display the thumbnail image and include the other information.

### Add-to-Cart Type Content Object

When the selected content object 600 is an add-to-cart type content object, the style menu 598 includes a product list button (not shown) and an optional transaction service link button (not shown). When the product list button is clicked, the e-commerce processing module 316 requests product information (e.g., product names) related to products in the product inventory database 22 available to the user from the web server 10. The data management module 11 registers the request, searches the product inventory database 22 for the products, and delivers the product information to the e-commerce processing module 316. The e-commerce processing module 316 displays the received product information (e.g., names) to the user. By way of a non-limiting example, the product information may be displayed in list format.

After the user selects a product, the e-commerce processing module 316 transmits a unique product identifier associated with the selected product to the data management module 11. The data management module 11 extracts detailed information related to the product (actual price, sales price, etc.) associated with the product identifier from the product inventory database 22. The data management module 11 delivers the extracted product information to the e-commerce processing module 316. The e-commerce processing module 316 modifies the add-to-cart type content object to display the received product information in the editing region 514 with the help of the content rendering module 318. For example, the add-to-cart type content object may display a product name, price, description, and the like.

When the optional transaction service link button (not shown) is clicked, the user provides any information necessary to link the add-to-cart type content object to the electronic transaction service 45 that will complete the purchasing transaction with a customer. For example, the user may specify the transaction page (not shown) to which a customer will be directed after selecting the add-to-cart type content object. Alternatively, the user may simply specify the electronic transaction service 45 and the system 2 will automatically link the add-to-cart type content object to the electronic transaction service 45.

By way of yet another non-limiting example, the system 2 may be preconfigured for use with a particular electronic transaction service and may configure each add-to-cart type content object to operate with that electronic transaction service. Further, the product information in the product inventory database 22 may include information necessary for the electronic transaction service 45 to identify the product and complete the transaction. This information may be incorporated into each add-to-cart type content object and transmitted to the electronic transaction service 45 when the customer selects an add-to-cart type content object.

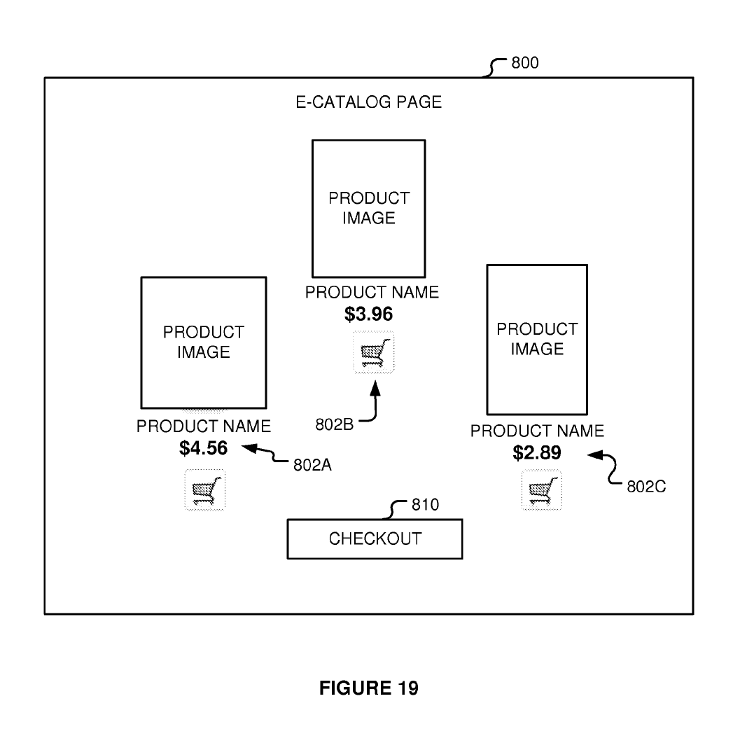

Referring to FIG. 19, when a purchaser clicks on an add-to-cart type content object (e.g., add-to-cart type object 802A) displayed in the final medium 800 (e.g., a webpage), the e-commerce processing module 316 directs the purchaser to the transaction page of the electronic transaction service 45 whereat the purchaser provides any additional information necessary to complete the transaction. By way of a non-limiting example, the electronic transaction service 45 may be Google Checkout service, PayPal service, and the like.

### Checkout Type Content Object

When the selected content object 600 is a checkout type content object, the style menu 598 includes an optional transaction service link button (not shown). When the optional transaction service link button (not shown) is clicked, the user provides any information necessary to link the checkout type content object to the electronic transaction service 45 that will complete the purchasing transaction with a customer. For example, the user may specify the transaction page (not shown) to which a customer will be directed after selecting the checkout type content object. Alternatively, the user may simply specify the electronic transaction service 45 and the system 2 will automatically link the checkout type content object to the electronic transaction service 45.

By way of yet another non-limiting example, the system 2 may be preconfigured for use with a particular electronic transaction service and may configure the checkout type content object to operate with that electronic transaction service. Further, the product information in the product inventory database 22 may include information necessary for the electronic transaction service 45 to identify the product and complete the transaction. This information may be incorporated into each add-to-cart type content object and transmitted to the electronic transaction service 45 for each add-to-cart type content object selected by the customer when the customer selects the checkout type content object.

Referring to FIG. 19, when a purchaser clicks on the checkout type content object 810 displayed in the final medium 800, the e-commerce processing module 316 directs the purchaser to the transaction page of the electronic transaction service 45 whereat the purchaser provides any additional information necessary to complete the transaction. The e-commerce processing module 316 also transmits product identifying information of associated with any of the add-to-cart type objects 802A, 802B, and 802C selected by the purchaser. By way of a non-limiting example, the electronic transaction service 45 may be Google Checkout service, PayPal service, and the like.

### Advertisement Type Content Object

When the selected content object 600 is an advertisement type content object, the style menu 598 includes a preview button (not shown). When the preview button is clicked, the content rendering module 318 displays the advertisement of the advertisement type content object. When the advertisement is displayed and the mouse cursor is positioned over the advertisement type content object, the content rendering module 318 outputs any audio signals associated with the advertisement type content object.

4. Preview Function

Returning to FIG. 6, when the preview control 596 of the file menu 588 is activated by the user, the system 2 enters preview mode. In preview mode, the Rich Content item is rendered to preview a display version of the Rich Content item. The display version is the version that is to be viewed by customers after distribution to a different final medium. A back-to-edit mode button (not shown) is displayed on the previewed display version of the Rich Content. When activated, the back-to-edit mode button returns the system 2 to edit mode. When in preview mode and edit mode, the system 2 uses the same content rendering module 318 to display the Rich Content item that is used to generate the final version for distribution. Thus, the system implements an easy to use “What You See Is What You Get” (“WYSIWYG”) user interface.

5. Distribute Function

To generate the final version of the Rich Content item for distribution to a final medium (such as posting the Rich Content item to a website), the user activates the save control 592. After the save control 592 is activated, the content management module 319 transmits any meta information (e.g., title, keywords, etc.) entered by the user and information related to all of the content objects and their arrangement in the editing region 514 to the web server 10. By way of a non-limiting example, the content management module 319 may convert this information into XML format before transmitting it. The receiving data management module 11 receives the information and stores it in the content storage location 26.

To distribute the saved Rich Content item to a final medium (e.g., a third party website), a segment of embeddable code (e.g., HTML) is generated. When the user activates the export control 594, the content management module 319 generates the segment of embeddable code and displays it. To distribute the Rich Content, the user copies the segment of embeddable code and pastes it into the final medium. The segment of embeddable code may be configured to execute with the help of a RIA browser plug-in, such as Microsoft Silverlight, Adobe Flash, and the like. However, if a search engine friendly display of the Rich Content item in the final medium is desired, the segment of embeddable code may be configured in a search engine friendly format such as HTML. The convert control 595 may be used to generate a segment of embeddable code that may be viewed in a standard web browser without the use of a plug-in or other software.

In particular implementations, the segment of embeddable code may include two separate code segments: a first code segment for use with a RIA Internet browser plug-in (such as Microsoft Silverlight, Adobe Flash, and the like); and a second code segment for use with an Internet browser without the RIA browser plug-in. As mentioned above, the first code segment may not be search engine friendly. Thus, by including the second code segment, the segment of embeddable code can be made search engine friendly independently of which of the first and second code segments is actually used to generate the display in the Internet browser. In other words, the first code segment may be used to generate a display in the Internet browser and the second code segment may be used to make the display search engine friendly.

Embodiments of the segment of embeddable code that include the first and second code segments also include a detection module that determines whether the Internet browser has an appropriate RIA browser plug-in installed. If the detection module determines the Internet browser has an appropriate RIA browser plug-in installed, the detection module instructs the Internet Browser to load the plug-in and instructs the plug-in to render the first code segment to generate a display substantially equivalent to the Rich Content item. If the detection module determines the Internet browser does not have the appropriate RIA browser plug-in installed, the detection module instructs the Internet Browser to render the second code segment (e.g., a HTML representation of the Rich Content item) to generate a display substantially equivalent to the Rich Content item.

6. Broadcast Function

The broadcast control 593 in the file menu 588 is used to broadcast Rich Content in real time over the Internet to a viewer. When the broadcast control 593 is activated, the channel management module 51 of the broadcast server 50 classifies the user as a Broadcaster, generates a broadcast channel, and assigns the broadcast channel a channel number. The channel number assigned may have been requested by the user or automatically assigned by the channel management module 51 from a preexisting collection of channel numbers not in use. Referring to FIG. 16, once the channel number has been assigned, a broadcast screen 770 is displayed to the user on the display unit 147. The broadcast screen 770 has a Rich Content editing region 772, a video signal display portion 774, audio playback controls 776, a text chat display portion 777, and whiteboard tools 778 (e.g., colored pens, brushes, erasers, and the like). The broadcast screen 770 may also include the toolbar 510.

The Rich Content editing region 772 may be characterized as an electronic whiteboard or chalkboard. Content objects may be inserted into the Rich Content editing region 772 using the toolbar 510. The whiteboard tools 778 may be used to write and/or draw within the Rich Content editing region 772 on and around the content objects displayed therein.

7. Watch Function

Returning to FIG. 6, the watch control 597 in the file menu 588 is used by a viewer to view Rich Content broadcast in real time over the Internet. Referring to FIGS. 1 and 17, after the watch control 597 is activated, the channel management module 51 of the broadcast server 50 classifies the user as a viewer and delivers to the viewer a list 780 of channels currently configured for use. The viewer selects the channel he/she would like to view from the list. The same broadcast screen 770 (see FIG. 16) displayed to the Broadcaster is then displayed to the viewer on the viewers display unit 147.

Turning to FIG. 16, after the broadcast channel has been generated and selected for viewing by one or more viewers, all of the actions (generation, modification, deletion, repositioning) taken with respect to the content items displayed in the broadcast screen 770 are transmitted to all of the viewers (including the Broadcaster) viewing the broadcast channel. The transmitted data is received by the content receiving module 323 of the client program 31 operated by each of the viewers (including the Broadcaster) and is displayed by the content rendering module 318 on the display unit 147 of each of the viewers.

If XML code as opposed to binary code is used to broadcast the Rich Content and actions with respect thereto (generation, modification, deletion, reposition, etc.) considerable bandwidth can be saved. In situations where only limited bandwidth is available, such as when a dial-up modem is used, the content transmission module 322 may be configured to compress the data before transmission.

For example, if the Broadcaster clicks on the image control 552 in the toolbar 510, the content object generation module 321 inserts an image type content object with basic or default attributes in the Rich Content editing region 772. At the same time, the content transmission module 322 transmits the image type content object to all of the viewers viewing the broadcast channel. To transmit the image type content object, the content transmission module 322 may serialize the image type content object into a segment of XML code that is transmitted to the viewers. By way of another example, if the Broadcaster moves the image type content object in the Rich Content editing region 772 from a first location (e.g., x₁, y₁) to a second location (e.g., x₂, y₂), the content transmission module 322 transmits the modified second location information (e.g., in a XML format) to all of the viewers viewing the broadcast channel.

When a webcam or microphone is used during the broadcast, the video/audio transmission module 324 executes encoding through a CODEC such as MPEG or H.264, and transmits the video/audio data to all of the viewers viewing the broadcast channel. The video/audio data transmitted by the Broadcaster is received by the video/audio receiving module 325 of the client program 31 operated by the viewer. The video/audio receiving module 325 performs decoding operations on the received video/audio data. Any decoded video data is displayed on the viewer's screen in the video signal display portion 774 and any decoded audio data is outputted through the viewer's speakers. The audio output may be modified using the audio playback controls 776.

During the broadcast, the Broadcaster and one or more of the viewers can have bi-directional text chats. The chat module 326 loaded on both the client programs 31 of the Broadcaster and viewer(s) sends, receives, and displays text input during the chat by the Broadcaster and viewer(s).

The Broadcaster and the viewer can draw pictures using various whiteboard tools 778, such as colored pens, or add annotations on top of the Rich Content in the Rich Content editing region 772. When a first user draws a picture in the Rich Content editing region 772 using various colored pens, the electronic chalkboard module 327 of the client program 31 converts the drawing to color and coordinate information, and transmits that information (e.g., in a XML format) to over the broadcast channel to all other viewers. The electronic chalkboard module 327 of the other viewers receives the color and coordinate information, interprets the information, and displays the pictures to the viewers in the Rich Content editing region 772 displayed on their display units 147. The electronic chalkboard module 327 includes any functions common to electronic drawing applications, including a pen, an eraser, a color palette, a pen width control, and the like.

If during a broadcast, the channel management module 51 detects that P2P communication between the Broadcaster and one or more of the viewers is not possible, the content transmission module 322 transmits the broadcast related data to the relay or broadcast module 52 of the broadcast server 50. The broadcast module 52 receives broadcast related data and transmits it to the viewers with whom P2P communication is not possible.

The Broadcaster and/or viewer(s) may save the Rich Content item created in the Rich Content editing region 772 using the save control 592 (described above). Further, the Broadcaster and/or viewer(s) may distribute the Rich Content item created in the Rich Content editing region 772 by activating the export control 594, and copying and pasting the segment of embeddable code generated thereby in a final medium.

### Computing Device

The exemplary hardware and operating environment of FIG. 18 includes a general-purpose computing device 120 in the form of a computer. As mentioned above each of the web server 10, the storage device 20, the client computing device 30, the external service processor 40, and the broadcasting server 50 may be implemented using the computing device 120.

The computing device 120 includes a processing unit 121, a system memory 32, and a system bus 123 that operatively couples various system components, including the system memory 32, to the processing unit 121. There may be only one or there may be more than one processing unit 121, such that the processor of computing device 120 includes a single central-processing unit (CPU), or a plurality of processing units, commonly referred to as a parallel processing environment. The computing device 120 may be a conventional computer, a distributed computer, or any other type of computer.

The system bus 123 may be any of several types of bus structures including a memory bus or memory controller, a peripheral bus, and a local bus using any of a variety of bus architectures. The system memory may also be referred to as simply the memory, and includes read only memory (ROM) 124 and random access memory (RAM) 125. A basic input/output system (BIOS) 126, containing the basic routines that help to transfer information between elements within the computing device 120, such as during start-up, is stored in ROM 124. The computing device 120 further includes a hard disk drive 127 for reading from and writing to a hard disk, not shown, a magnetic disk drive 128 for reading from or writing to a removable magnetic disk 129, and an optical disk drive 130 for reading from or writing to a removable optical disk 131 such as a CD ROM, DVD, or other optical media.

The hard disk drive 127, magnetic disk drive 128, and optical disk drive 130 are connected to the system bus 123 by a hard disk drive interface 132, a magnetic disk drive interface 133, and an optical disk drive interface 134, respectively. The drives and their associated computer-readable media provide nonvolatile storage of computer-readable instructions, data structures, program modules, and other data for the computing device 120. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment.

A number of program modules may be stored on the hard disk drive 127, magnetic disk 129, optical disk 131, ROM 124, or RAM 125, including an operating system 135, one or more application programs 136, other program modules 137, and program data 138. A user may enter commands and information into the computing device 120 through input devices such as a keyboard 140 and pointing device 142. Other input devices (not shown) may include a microphone, joystick, game pad, satellite dish, scanner, or the like. These and other input devices are often connected to the processing unit 121 through a serial port interface 146 that is coupled to the system bus 123, but may be connected by other interfaces, such as a parallel port, game port, or a universal serial bus (USB). A display unit 147, such as a monitor or other type of display device is also connected to the system bus 123 via an interface, such as a video adapter 148. In addition to the display unit 147, computers typically include other peripheral output devices (not shown), such as speakers and printers.

The computing device 120 operates in a networked environment using logical connections to one or more remote computers, such as remote computer 149. These logical connections are achieved by a communication device coupled to or a part of the computing device 120 (as the local computer). Implementations are not limited to a particular type of communications device. The remote computer 149 may be another computer, a server, a router, a network PC, a client, a peer device or other common network node, and typically includes many or all of the elements described above relative to the computing device 120, although only a memory storage device 150 has been illustrated in FIG. 2. The logical connections depicted in FIG. 2 include a local-area network (LAN) 151 and a wide-area network (WAN) 152. Such networking environments are commonplace in offices, enterprise-wide computer networks, intranets and the Internet. The network 4 may include any of these networking environments.

When used in a LAN-networking environment, the computing device 120 is connected to the local area network 151 through a network interface or adapter 153, which is one type of communications device. When used in a WAN-networking environment, the computing device 120 typically includes a modem 154, a type of communications device, or any other type of communications device for establishing communications over the wide area network 152, such as the Internet. The modem 154, which may be internal or external, is connected to the system bus 123 via the serial port interface 146. In a networked environment, program modules depicted relative to the personal computing device 120, or portions thereof, may be stored in the remote memory storage device 150. It is appreciated that the network connections shown are exemplary and other means of and communications devices for establishing a communications link between the computers may be used.

The computing device 120 and related components have been presented herein by way of particular example and also by abstraction in order to facilitate a high-level view of the concepts disclosed. The actual technical design and implementation may vary based on particular implementation while maintaining the overall nature of the concepts disclosed.

### Exemplary Implementation

Most e-commerce applications provide a template interface coupled to a product database. When a product is selected by a user, information is extracted from the database and used to populate predefined areas of the template interface. This approach leads to each product page having a similar appearance differing only with respect to product details (e.g., image of product, price, product attributes, etc.). These interfaces typically offer a single product for sale per page. Therefore, to purchase multiple related products, a user must generate a page for each product one at a time and add each product individually to an online (virtual) shopping cart.

This type of interface is not particularly useful for businesses that sell items based on their coordination with other products. For example, many businesses are based a particular aesthetic. Further, many customers prefer to buy items already coordinated by professionals. For this reason, department stores dress manikins and store windows. Magazines and catalogs also display products in a coordinated manner.

Because the system 2 allows a user to create an advertisement layout having any number of add-to-cart type objects, a user can create an e-commerce page that resembles a magazine or catalog page. For example, referring to FIG. 19, a user can layout a Rich Content item for three coordinated products having three add-to-cart type objects 802A, 802B, and 802C. A customer can select any portion of the three add-to-cart type objects without having to visit another page. When the user has finished selecting items, the user can select the checkout type content object 810 to complete the purchase.

In this manner, a user can create a website in much the same manner catalogs are created. For example, a user could upload a professional photograph of table setting. Then, the user could insert text type content objects and arrow type content objects to describe and annotate the items for sale. The user could place an add-to-cart type content object next to each item for sale. Finally, the user could add a checkout type content object to the catalog page. In this manner, the user has created a fully interactive catalog page, complete with search engine friendly information, without detailed knowledge of SEO or computer languages. The user can manually layout each page to best present the user's products.

### Exemplary Implementation

A user may use the broadcast functionality of the system 2 to offer interactive customer service. For example, if a customer has a question, the customer may call, email, or otherwise contact the seller. The seller or customer may recommend using the broadcast features of the system 2. After the seller or customer has generated a broadcast channel, the other party can view the broadcast channel. Then, the seller and customer can communicate over the broadcast channel one-on-one. In this manner, the seller can provide individualized customer service to remotely located customers. For example, the seller can recommend products, view customer generated content, etc.

The customer can take a photograph with the camera 62 of the user's mobile station 60, send it to the system 2, and display the photograph to the seller by inserting an image type content object into the Rich Content editing region 772. After viewing the photograph, the seller can comment on it by entering text into the text chat display portion 777 or by writing in the Rich Content editing region 772 using the whiteboard tools 778. For example, the seller can provide a cost estimate to the customer based on the photograph displayed by the image type content object in the Rich Content editing region 772.

In addition to recommending products, the seller can insert photographs of products into the Rich Content editing region 772 using image type content objects, and add annotations to the Rich Content editing region 772 using the whiteboard tools 778, text type content objects, arrow type content objects, and the like. The seller can also explain product features using the text chat display portion 777, the video signal display portion 774, and the audio chat functionality.

The seller can also insert one or more add-to-cart content type objects to the Rich Content editing region 772 that allow the customer to purchase the products associated with the add-to-cart content type objects.

By placing multiple add-to-cart type objects on the Rich Content editing region 772, the seller can create a “real-time” customized online catalog. For example, during the one-on-one broadcast session, the customer can ask the seller in the text chat display portion 777 to identify the top five best selling notebook computers. The seller can respond by inserting an add-to-cart type object for each of the seller's best selling notebook computers on the Rich Content editing region 772. The customer can purchase one of the notebook computers during the broadcast session by clicking on one of the add-to-cart type objects, which directs the customer to a transaction page of the electronic transaction service 45 whereat the customer completes the transaction.

### Exemplary Implementation

The system 2 may be used to implement map based customer service. The map service 44 provider may associate particular map locations (e.g., latitude and longitude) with a link to a website. In this manner, a user may use hyperlinks embedded in a map image generated by the map service 44 to navigate to a website operated by a business.

The website operated by the business may include a hyperlink to a Rich Content interactive customer service application, which connects the user to a previously generated broadcast channel, or automatically opens a broadcast channel with the client program 31 executing on a client computing device 30 at the business.

Using this broadcast channel, the user can interact with a second user at the business who can answer questions, suggest products, offer products for online purchase, and the like.

The users may communicate by editing the Rich Content in the Rich Content editing region 772 (see FIG. 16). They may also communicate using the electronic chalkboard modules 327, video cameras, microphones, and the like.

Depending upon the implementation details, the system 2 may provide one or more of the following:

1. Creation of Rich Content without performing successive operations using multiple software applications;

2. Creation of Rich Content without knowledge of sophisticated software applications, such as Adobe Photoshop, or computer languages, such as HTML or CSS;

3. Creation of Rich Content across many platforms that is also viewable across multiple browsers (Internet Explorer, Firefox, Safari, Opera, Konqueror, etc.);

4. Easy distribution of Rich Content to third party services, such as MySpace, Facebook, LiveJournal, etc., using copy and paste;

5. Automatic update of Rich Content distributed to many mediums because content items used to create Rich Content are centralized in the storage device 20 and distributed Rich Content is generated using references to centralized storage device 20;

6. Generation of Rich Content in a format that can be indexed by search engine crawlers without separate manual SEO;

7. Generation of Rich Content in a format that can be rendered using standard HTML;

8. Generation of Rich Content that can be integrated into blogs, mini homepages, message boards, cafes, web pages, e-mail, instant messengers, e-learning, online newspapers, social networking, and the like; and

9. Real time information exchange and cooperation between users using the real time broadcasting functionality of the system 2.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for creating rich content displayable on a webpage by a web server, the system being for use by a user, the system comprising:
a plurality of content files each stored on a server in a storage location;
a rich content editor displayed in a display unit coupled to a client computing device in communication with the server over a network, the rich content editor comprising an editing region and a plurality of content objects each insertable into the editing region by the user and when inserted, displayable inside the editing region, each of the plurality of content objects being linkable to the storage location of a selected one of the plurality of content files stored on the server;
a rich content item displayable and editable by the rich content editor, the rich content item comprising at least a portion of the plurality of content objects, each having a position inside the editing region and being linked to the storage location of a selected one of the plurality of content files stored on the server; and
a code generation function configured to generate a distributable code segment operable to generate a first display displayable on a webpage by a web server based on the rich content item, the first display being substantially equivalent to the rich content item displayed in the editing region when displayed by a web server on a webpage.

2. The system of claim 1, wherein the rich content editor is displayed by an Internet browser application executing on the client computing device.

3. The system of claim 1, further comprising a preview function configured to generate a second display substantially equivalent to the first display when displayed on a webpage by a web server.

4. The system of claim 1, wherein the plurality of content objects comprises an embedded code type object configured to receive a segment of code, identify a service associated with the code, request information from the service related to the segment of code, and display the requested information in the editing region.

5. The system of claim 1, further comprising a content file processing function configured to upload a content file from the client computing device to the server, store the uploaded content file in a storage location, and add the uploaded content file to the plurality of content files.

6. The system of claim 1 for use with a content file sharing service, the system further comprising a content file sharing function configured to use the content file sharing service to identify a particular content file, upload the particular content file to the server, store the uploaded content file in a storage location, and add the uploaded content file to the plurality of content files.

7. The system of claim 1, wherein the rich content item comprises a segment of XML code.

8. The system of claim 1, wherein the distributable code segment comprises a segment of HTML code.

9. A system for creating rich content displayable on a webpage by a web server, the system being for use by a first user and a second, the system comprising:
a plurality of content files each stored on a server in a storage location;
a first rich content editor displayable in a display unit coupled to a first client computing device operated by the first user, the first client computer being in communication with the server over a network;
a second rich content editor displayable in a display unit coupled to a second client computing device operated by the second user, the second client computer being in communication with the server over the network, each of the first and second rich content editors comprising an editing region and a plurality of content objects each insertable into the editing region by the first and second user, respectively, when inserted, the content object is displayable inside the editing region, each of the plurality of content objects being linkable to the storage location of a selected one of the plurality of content files stored on the server; and
a broadcast function operable to open a broadcast channel between the first user and the second user, display the first rich content editor in the display unit coupled to the first client computing device, and display the second rich content editor in the display unit coupled to the second client computing device, when one of the first and second users inserts one of the plurality of content objects into the editing region of one of the respective first and second rich content editors, the broadcast function displaying the inserted content object in the editing region of both the first and second rich content editors.

10. The system of claim 9, further comprising a save function operable to store a rich content item comprising any content objects inserted into the editing region of the first and second rich content editors, and
for each inserted content object, a location of the inserted content object within the editing region of the first and second rich content editors.

11. The system of claim 10, wherein the rich content item is stored as a segment of XML code.

12. The system of claim 10, wherein for at least a portion of the inserted content objects, the rich content item further comprises a link to a storage location of a selected one of the plurality of content files stored on the server.

13. The system of claim 9, further comprising:
a rich content item created by the first and second users by the insertion of content objects into the editing region of the first and second rich content editors, the rich content item being displayed inside the editing region of the first and second rich content editors by the broadcast function; and
a code generation function configured to generate a distributable code segment operable to generate a display displayable on a webpage by a web server based on the rich content item, the display being substantially equivalent to the rich content item displayed in the editing region of the first and second rich content editors when displayed by a web server on a webpage.

14. A purchasing interface displayable to a buyer on a display device, the purchasing interface being for use with an electronic transaction service executing on a server in communication with the purchasing interface over a network, the electronic transaction service being configured to receive a purchase request indentifying a plurality of products from the purchasing interface over the network, and in response to receiving the purchase request, complete a purchase of the plurality of products identified in the purchase request, the purchasing interface comprising a product offerings display screen having:
a plurality of selectable purchasing objects each associated with a different product, when selected, each selectable purchasing object indicating a desire of a buyer to purchase the product associated with the selectable purchasing object, more than one of the plurality of selectable purchasing objects being selectable before a purchase request to purchase the product associated with each selectable purchasing object is transmitted to the electronic transaction service; and
a selectable purchase indicator that when selected creates a purchase request identifying each product associated with each of the selectable purchasing objects selected by the buyer and transmits the purchase request to the electronic transaction service over the network.

15. The purchasing interface of claim 14 for use with a product database storing information related to each of the different products associated with each of the plurality of selectable purchasing objects and a data management function configured to extract the information related to each of the different products associated with the plurality of selectable purchasing objects from the database and provide the extracted information to the plurality of selectable purchasing objects,
wherein each of the plurality of selectable purchasing objects comprises a display portion, and
the display portion of each of the plurality of selectable purchasing objects displays information related to the product associated with the selectable purchasing object extracted from the database by the data management function and provided to the selectable purchasing object by the data management function.

16. A method performed by a first user, the method being for use with an online map service that provides navigable electronic maps each having embedded therein a link to a website operated by a business, the method comprising:
navigating one of the navigable electronic maps provided by the service to the embedded link;
activating the link and being directed thereby to the website operated by the business, the website being configured to initiate a customer service application that broadcasts information between the first user and a user associated with the business;
activating the control to initiate the customer service application, the customer service application displaying a Rich Content editing region to both the first user and the user associated with the business;
inserting content into the Rich Content editing region for broadcast by the customer service application to the user associated with the business; and
viewing content inserted into the Rich Content editing region by the user associated with the business and broadcast to the first user by the customer service application.

17. The method of claim 16, wherein the content inserted into the Rich Content editing region by the user associated with the business comprises an add-to-cart type object operable to initiate a purchase of a product, and the method further comprises activating the add-to-cart type object thereby initiating the purchase of the product.

18. The method of claim 16, wherein the customer service application displays a text chat display region to both the first user and the user associated with the business, the method further comprising chatting with the user associated with the business by entering text into the text chat display region and viewing text entered into the text chat display region by the user associated with the business.

19. The method of claim 16, wherein the customer service application displays a pen tool to both the first user and the user associated with the business, and the method further comprises using the pen tool to create a drawing in the Rich Content editing region, the drawing created being displayed in the Rich Content editing region displayed to both the first user and the user associated with the business.

20. The method of claim 16, wherein the customer service application broadcasts the content inserted into the Rich Content editing region to the user associated with the business in XML format.

21. The method of claim 16, further comprising:
saving the content in the Rich Content editing region as a rich content item; and
at a later time, displaying the saved rich content item to at least one of the user and the user associated with the business in the Rich Content editing region.

22. A method comprising:
capturing an image with a camera coupled to a mobile station having an identification number and being associated with a user;
transmitting a message comprising the identification number of the mobile station and the image to a predetermined email address associated with a server;
at the server, receiving the message, obtaining the identification number of the mobile station and the image from the message, and storing the image in a storage location associated with the mobile station and accessible by the user associated with the mobile station;
receiving a request for the image from the user associated with the mobile station; and
reading the image from the storage location and providing the image to the user.

23. The method of claim 22, wherein transmitting the message to the server comprises transmitting the message to a messaging gateway, and receiving the message at the server comprises connecting to the messaging gateway and downloading the message from the messaging gateway.

24. The method of claim 23, wherein the messaging gateway comprises a Short Message Service (“SMS”) gateway.

25. The method of claim 23, further comprising:
periodically contacting the messaging gateway to determine whether any messages have been received by the messaging gateway.

26. The method of claim 22, wherein the message comprises a Multimedia Message Service (“MMS”) message.

27. A method performed by a server having a database associating telephone numbers of mobile stations to users, the method comprising:
periodically contacting a messaging gateway to determine whether any messages have been received by the messaging gateway, each message having an image file and a telephone number associated with a sending mobile station;
downloading a plurality of messages received by the messaging gateway;
extracting the telephone number of the sending mobile station from each message downloaded;
for each message downloaded, using the database associating telephone numbers of mobile stations to users to identifying the user associated with the telephone number of the sending mobile station extracted from the message;
extracting the image file from each message downloaded;
storing each image file extracted in a storage location associated with the user identified for the message from which the image file was extracted;
receiving a request from a particular user for any image files stored in the storage location associated with the user; and
in response to receiving the request, providing any image files stored in the storage location associated with the particular user to that user.

28. The method of claim 27, wherein the request from the particular user for any image files stored in the storage location associated with the user is received from a web browser application operated by the user, and
providing any image files stored in the storage location associated with the user to the user comprises displaying at least one of the image files in the web browser application operated by the user.

29. The method of claim 27, wherein the messages received by the messaging gateway comprise Multimedia Message Service (“MMS”) messages.

30. The method of claim 27, wherein the messaging gateway comprises a Short Message Service (“SMS”) gateway.

31. A method comprising:
capturing an image with a camera coupled to a mobile station having an identification number and being associated with a user;
dialing a predetermined identification number associated with a server;
transmitting a message comprising the identification number of the mobile station and the image to the server;
at the server, receiving the message, obtaining the identification number of the mobile station and the image from the message, and storing the image in a storage location associated with the mobile station and accessible by the user associated with the mobile station;
receiving a request for the image from the user associated with the mobile station; and
reading the image from the storage location and providing the image to the user.
